(19) United States
(12) Patent Application Publication
(10) Pub. No.: US 2007/0295568 A1
(43) Pub. Date: Dec. 27, 2007

(54) Electromagnetic Retarder Comprising Means Ensuring Ventilation

(76) Inventor: Claudiu Vasilescu, Paris (FR)

Correspondence Address: Longacre & White, 6550 Rock Spring Drive,, Suite 240, Bethesda, MD, 20817, US

(21) Appl. No.: 10/580,409

(22) PCT Filed: Dec. 13, 2004
(86) PCT No.: PCT/FR04/03199

§ 371 Date: Jan. 26, 2007

(30) Foreign Application Priority Data
Dec. 19, 2003 (FR) 0315092

(51) Int. Cl. B60L 7/28; H02K 49/04

(52) U.S. Cl. 188/267; 188/274

(57) ABSTRACT

A retarder (100) including a stator (170) and/or a housing (102) surrounding or encasing a rotor (101), a mechanism (140-142) for producing an air current and at least one inlet (120) enabling air current to enter and at least one outlet (120) used to evacuate the air current. The outlet (121-123) is created between two cooling chambers (111-112) or through several cooling chambers which are borne by the housing and/or stator of the retarder.

### FIELD OF THE INVENTION

The present invention concerns an electromagnetic retarder comprising means for providing ventilation. One of the aims of the invention is to facilitate cooling of such a retarder and in particular cooling of its coils. Another purpose of the invention is to reduce the noise generated by operation of the retarder. The present invention finds a particularly advantageous, but not exclusive, application for retarding the movement of a vehicle of the heavyweight type such as a lorry or a bus.

### PRIOR ART

In general terms, an electromagnetic retarder assists the braking of a vehicle in order to make it safer and more enduring. An electromagnetic retarder comprises at least one stator and at least one rotor. The stator is connected to a gearbox casing or to a transmission axle casing of a vehicle. In this case, a transmission shaft is not cut in order to mount the retarder. When the transmission shaft is not cut, a “Focal” (registered trade mark) retarder is spoken of. In a variant, the stator is fixed to the vehicle chassis and the transmission shaft is cut.

The rotor, for its part, is connected to a plate coupled to a flange of a universal joint of the transmission shaft. This plate is coupled to an input shaft of the vehicle axle or to an output shaft of the gearbox or to a connecting shaft. This connecting shaft can be connected to another plate when the transmission shaft is cut. In one example, the rotor is in two parts and is situated on each side of a stator and turns about the axis of the stator.

In an embodiment described in the document FR-A-2577357, the stator of the electromagnetic retarder carries a ring of coils, and generates a magnetic field. More precisely, each coil is mounted on a core made from magnetic material fixed to the stator. When it carries the coils, the stator is inductive. In the document FR-A-2577357, the rotor is produced from a magnetic material and is induced. This rotor is conformed so as to have fins that provide ventilation of the retarder. In another embodiment described in the document EP-A-0331559, the rotor carries the ring of coils and the cores. In this embodiment, the rotor is inducing and the stator is induced. This stator also carries a chamber inside which a fluid flows for its cooling. Such a retarder is said to be a water-cooled retarder or a Hydral retarder (registered trade mark).

The creation of a braking torque generated by an electromagnetic retarder is based on a principle of eddy currents. This is because the induced stator, inside which an inducing rotor turns, is subjected to an electromagnetic field. This field is generated by the coils mounted on the rotor which preferably function in pairs, each coil being wound around a projecting core belonging to the rotor. Each of the pairs of coils forms a magnetic field that closes from one core of the coil to another passing through the stator and through the rotor.

Thus, when the rotor starts to rotate, currents known as eddy currents arise inside the induced stator. These currents generate a braking torque that have a tendency to oppose the movement of the rotor. As the rotor turns with a drive shaft, this braking torque also opposes the movement of the drive shaft of the vehicle. This torque therefore participates in a slowing down or stoppage of the vehicle.

For a retarder comprising an inducing rotor, the eddy currents give rise to heating of the stator and rotor. This is because the currents passing through the stator and the coils produced from conductive materials have a tendency to heat the walls of the stator and the whole of the rotor. This heating phenomenon is referred to as Joule effect and is generally observable when an electric current passes through an electrical conductor. The power of an electromagnetic retarder is therefore limited by its capacity to discharge heat from the stator and coils.

Thus, in one example, the stator of a retarder dissipates a power of 300 kW and the coils of a retarder dissipate a not insignificant power of 8 kW. It is necessary to discharge heat associated with these powers in order to avoid a drop in performance and prevent any malfunctioning of the retarder.

Various systems are known for discharging this heat. For example, it is possible to use a fan integral with the rotor as described in the document EP-A-0331559. This generator generates a current of air in order to discharge heat dissipated by the rotor.

This document EP-A-0331559 also describes a solution in which the wall of the stator carries a cooling chamber allowing a circulation of a cooling fluid. An exchange of heat can then occur between the cold liquid of the cooling chamber and the hot walls of the stator. The heat from the wall of the stator can thus be discharged from the cooling liquid.

However, this cooling chamber system and the ventilation system have limits. This is because the cooling chambers make it possible to cool the stator effectively but, as they are distant from the coils, they do not cool them as effectively as desired.

As for the fans, they may generate a noise that is an audible nuisance very disagreeable for the driver. Moreover, fans can also be very bulky and increase the weight of the retarder. Being both bulky and heavy, these fans reduce the adaptability of the retarder for a given gearbox or rear axle. These fans are integral with the shaft or rotor but the path of the air flow that it generates is random, difficult and not optimised.

In addition, these fans consume a great deal of energy.

The over-consumption of the retarder can be explained by the fact that a variation in pressure of a fluid in a given environment gives rise to a circulation of particles in this environment. Thus, for a given variation in pressure, there exist several possible flow rates of fluid. This flow rate is determined by a path of the fluid and the difficulty that this fluid has had in circulating in the environment.

### OBJECT OF THE INVENTION

Thus the object of the present invention is to resolve these problems of the circulation of air through the retarder, the size of the external fan and the audible nuisance generated by this fan.

To this end, the invention uses an electromagnetic retarder that comprises perforations or apertures on its contour in order to facilitate the passage of a current of air. More precisely, the retarder according to the invention comprises inlet apertures and discharge apertures produced in walls of the retarder in order to facilitate circulation of a current of air. A current of air can in fact enter through an inlet aperture produced in general in a radial wall of the retarder or inclined with respect to the rotor shaft and leave the retarder through a discharge aperture produced either in a radial wall or in an inclined wall, or in a wall parallel to the axis of the retarder. Naturally the retarder can comprise several inlet apertures and several outlet apertures in order to provide an entry and discharge of intense air currents.

By virtue of the invention novel possibilities are offered. Thus it is possible to reduce the heat exchange surface and therefore the bulk and size of the retarder, whilst keeping its performance. In a variant, the size of the retarder can be kept and its performance increased. The retarder can function in an environment at a higher temperature. It is possible to install the retarder in particular by means of a speed multiplier acting on the shaft of the retarder rotor, in the space available, in particular adjacent to the vehicle engine or any other source of heat. The weight of the retarder can be reduced. The solution according to the invention makes it possible to decrease the noise generated by the circulation of an air current.

In general, the circulation of air currents in order to cool the retarder is not used alone but in combination with means of cooling by cooling liquid consisting of cooling chambers. The purpose of this combination is to optimise to a maximum the cooling of the retarder both at the core of the stator and at the core of the coils. By virtue of mixed cooling, it is possible to reduce further the size and weight of the retarder whilst having the desired performance. In a variant, the performance of the retarder is increased. A discharge aperture is produced between two independent cooling chambers filled with a cooling fluid. It is also possible to produce a discharge aperture through two water chambers separated from each other by a throttling throat. In one embodiment, the discharge apertures belong to the same chamber. In a variant, the inlet and discharge apertures can be offset with respect to the cooling chambers.

To create a current of air, the retarder comprises one or more blades attached to, that is to say integral with, a rotating element of the retarder. The blades in one embodiment belong to a fan attached to the rotating element. For example, the blades are fixed to a plate or profiled base attached, for example by welding, riveting, or screwing, to the rotating element concerned. In a variant, the blades are attached individually to the rotating element or issue therefrom.

Thus it is possible to attach, that is to say to fix, blades either to a rotor of the retarder or to a rotor of a generator, or to the shaft itself of the retarder. As the rotation of blades is provided by elements of the retarder in operation in a rotary movement, these blades do not consume any energy other than that related to the stirring of the air. This is because these blades profit from the rotation of a rotating part of the retarder. The blades therefore belong to an internal fan with a small diameter, that is to say with a smaller diameter than a fan external to the casing of the retarder.

In one example, these blades consume much less energy than blades of a fan external to the casing that have a greater diameter and therefore mechanical losses and that consume an enormous amount of electrical energy supplied by the retarder. In addition, the blades attached to the rotor of the retarder or to that of a generator make very little noise compared with the use of an external fan. The external fan is in fact very noisy and consumes a great deal of power because of the constraints that it must comply with and in particular because of its large diameter, which allows the passage of a current of air through the retarder with great pressure drops.

Various types of blade can be used for providing the creation of a current of air. Each type of blade imparts a particular path to the current of air. It is possible first of all to use blades of the centrifugal type that provide a suction of a current of air parallel to an axis of a shaft of a rotor and a discharge of this current of air perpendicular to the axis of the shaft. It is also possible to use blades of the helico-centrifugal type that provide suction of a current of air parallel to the axis of the shaft and discharge of this current of air along a path inclined with respect to this axis. Finally, it is possible to use blades of the axial type that provide suction of a current of air parallel to the shaft and discharge also parallel to the shaft.

In practice, a retarder can comprise a combination of several types of blade. A retarder according to the invention can also comprise several blades of one and the same type. The inlet and outlet apertures are produced according to the blades used and the path of the current of air. The purpose of these blades is to make the current of air come into contact with the coils in order to cool these coils. Thus blades of the helico-centrifugal type can, for a given retarder, create a current of air that flows over an accessible part of a coil, such as its head, as closely as possible.

Moreover, in order to create a certain current of air, it is possible to envisage the use of blades having different defined functions. For example, first blades can fulfill a role of suction blades, taking air from an external environment. These first blades transmit this air to second blades, which discharge them to the external environment. These combinations of blades make it possible to increase and adjust a flow of air inside the retarder. In a variant, third blades are situated outside the retarder.

In a retarder, currents of air comprising the same direction of suction can be generated by blades. Thus, in a particular embodiment, a retarder comprises blades that make a current of air enter through one end of the retarder and discharge it through another end. Thus a current of air passes through the retarder in the direction of its length in order to cool it. In a variant, the blades suck air through one end of the retarder and discharge this air at the centre.

In a variant, it is possible to use blades that provide the creation of currents of air having directions of suction different from each other. In this variant, the currents of air enter inside the retarder through the two ends of the shaft. When next these currents of air are discharged approximately at the centre of the retarder in order to cool all the rotors of the retarder. In this variant, the flow rate of the air inside the retarder is very great around rotors situated at the centre of the retarder, in a zone where the two currents of air meet. This very high flow rate cools the coils and the rotors at the centre of the retarder, which have a tendency to heat up greatly.

In particular embodiments, the bases of some blades and some rotors have a hole, channel or opening in them. These openings are produced so as to allow the passage of air from one rotor to another and ensure uniform cooling of the retarder. In addition, these openings allow cooling of the rotor and its coils by conduction. This is because the air comes into contact with the rotor inside the opening. As the rotor is produced from conductive material, this air has a tendency to cool the base of the rotor and then cool its centre, and then the coils. In a variant, these openings or channels are pierced in the rotor of the generator or in the rotor of the retarder. By virtue of the invention, the retarder is, in one embodiment, configured so as to have a shaft and a rotor turning at a greater speed than the shaft transmitting movement to at least one wheel of the vehicle, this transmission shaft being for example the shaft acting between the rear axle and the gearbox. The increase in speed can be achieved for example by means of a speed multiplier. Thus it is possible to reduce the size and weight of the retarder whilst having the required performance by virtue of the invention.

The invention therefore consists of an electromagnetic retarder comprising:

a rotor comprising coils and a body, this body being attached to

a shaft having an axis and driving the rotor in rotation,

a stator and/or casing surrounding or encasing the rotor,

means for producing a current of air,

a generator comprising a generating rotor and a generating stator,

characterised in that it comprises

at least one inlet aperture enabling this current of air to enter and at least one discharge aperture enabling this current of air to exit and in that the at least one discharge aperture is produced between two cooling chambers or through one or more cooling chambers carried by the casing and/or the stator of the retarder.

### BRIEF DESCRIPTION OF THE DRAWINGS

The invention will be better understood from a reading of the following description and the figures accompanying it. These figures are shown by way of illustration but are in no way limiting of the invention. These figures show:

FIG. 1: a partial schematic representation in axial section of a retarder according to the invention comprising cooling chambers and its walls, inlet and discharge apertures and blades attached to a rotor and to a generator.

FIG. 2: a partial schematic representation in plan view of discharge apertures passing through two cooling chambers separated from each other by a throttling throat.

FIG. 3a: a schematic representation in perspective of a retarder according to the invention inside which the currents of air have the same direction of suction.

FIG. 3b: a schematic representation similar to that in FIG. 3a of a retarder according to the invention inside which currents of air have opposite directions of suction.

FIG. 3c: a schematic representation similar to that in FIG. 3a of a retarder according to the invention inside which currents of air propagate in a parallel manner.

FIG. 3d: a schematic representation similar to FIG. 1 of apertures produced in a radial wall of a casing of a retarder.

FIG. 4: a schematic representation, similar to FIG. 1, of a retarder according to the invention that comprises blades that are variants of those used in the retarder in FIG. 1.

FIG. 5: a schematic representation, similar to FIG. 4, of a retarder according to the invention comprising blades that have a dedicated role of suction or discharge.

FIGS. 6a to 7b: a schematic representation in three dimensions of a rotor of a retarder according to the invention comprising fans respectively in exploded view and in perspective.

FIGS. 8a to 9d: a schematic representation in three dimensions of a casing of a retarder in various orientations.

FIGS. 10a to 14: partial views in axial section and front view of variants of retarders according to the invention comprising chambers transverse with respect to an axis of a shaft of a rotor.

FIGS. 15 to 19b: a partial schematic representation, partly in axial section and partly in perspective, of a retarder according to the invention in various orientations.

### DESCRIPTION OF EXAMPLE EMBODIMENTS OF THE INVENTION

The elements that are common to several figures keep the same reference.

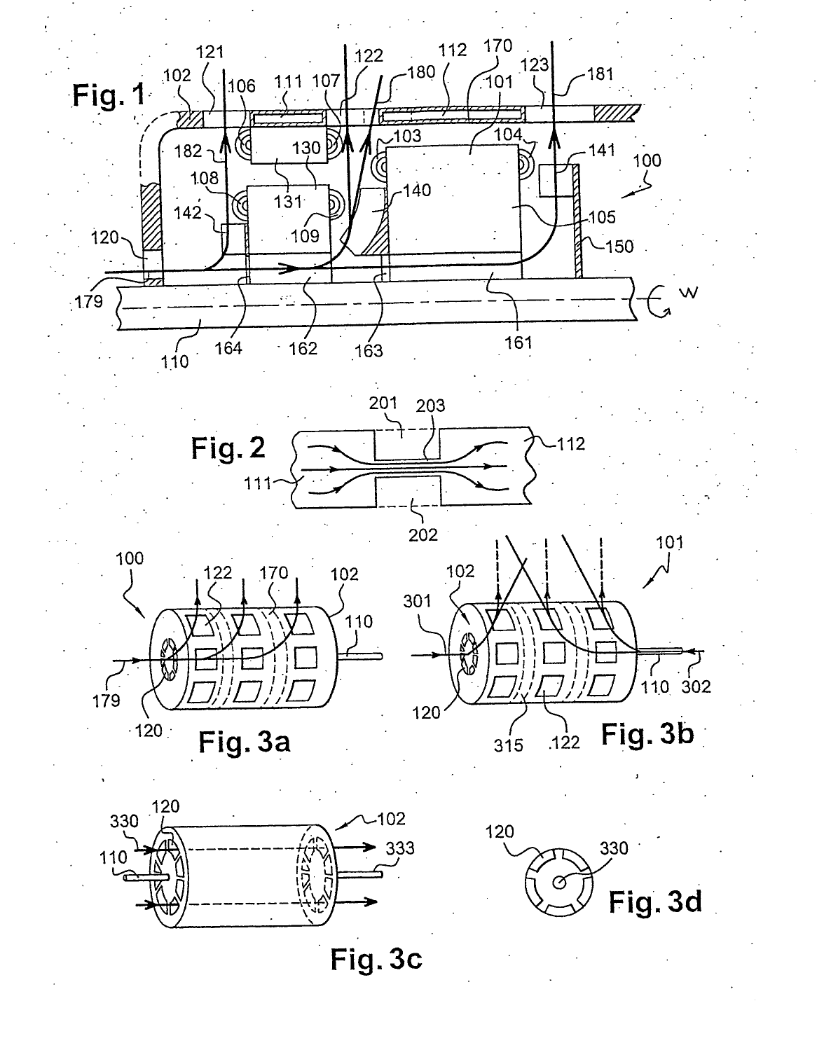

FIG. 1 shows a view in axial section of half of a retarder 100 according to the invention. The retarder 100 of the electromagnetic type comprises a casing 102 carrying a stator 170, a shaft 110, a rotor 101 fixed to the shaft 110, electrical coils (not referenced) carried by the rotor 101 comprising a body for this purpose, blades 140-142 rotationally fixed to the shaft 110 and a generator for electrically supplying the coils, here axially oblong in shape.

The casing 102 has apertures or openings 120-123 that, in combination with the blades 140-142, allow good discharge of the heat, in particular at the coils. The apertures 120-123 and the blades 140-142 belong to a ventilation device. The casing 102, hollow in shape, is configured so as to be mounted, preferably elastically, on a fixed part of a motor vehicle. The shaft 110 has an axis of symmetry that is the axis of the rotor 101.

Here the stator 170 is merged with the casing 102 made from magnetic material. In a variant, the stator is distinct from the casing 102 and is attached to it. The stator 170 surrounds the rotor 101, the body 105 of which has at its external periphery radial cores (not referenced) axially oblong in shape. The cores, and the body 105, are made from magnetic material.

Each coil comprises here an electrical wire wound around a core. The coils define with the cores a ring of inducing poles, with alternating polarity when they have an electric current passing through them. The coils function in pairs according to the retarding demanded.

In a known manner, these coils are supplied electrically by the generator, having for this purpose an inducing stator 131 surrounding an induced rotor 130 fixed to the shaft 110. The generator is offset axially with respect to the rotor 101, so that the rotors 130 and 101 are offset axially.

The rotor 130 has a diameter less than that of the rotor 101, the coils of which have heads 103, 104 extending in axial projection on each side of the body 105 of this rotor 101. The heads 103, 104 are therefore not masked and are therefore accessible.

The inducing stator 131 is fixed to the cylindrically shaped casing 102. This casing 102 therefore has at its external periphery an axially oriented annular peripheral wall on which the stator 131 is mounted internally.

A radial air gap exists on the one hand between the external periphery of the core of the rotor 101 and the internal periphery of the peripheral wall of the casing and on the other hand between the internal periphery of the stator 131 and the external periphery of the rotor 130.

As described in the document EP-A-0331359, an adjustment circuit is provided, comprising for example a manual control member for adjusting as required the excitation current for the inducing stator 131 with multiple poles generating an alternating current induced in the induced rotor 130.

The stator 131 and the rotor 130 have bodies carrying coils, as can be seen in FIG. 2 of this document EP-A-0331559, also showing a bridge rectifier acting between the rotor 130 and the coil of the rotor 101. This bridge, for example with diodes or transistors of the MOSFET type, rectifies the alternating current at the output from the rotor 130 into DC current for electrically supplying the coils fixed to the rotor 101.

These coils are wound in the aforementioned manner around cores of the body 105. More precisely, the coils are each mounted on a support made from electrically insulating material and slipped onto the core of the associated support. For simplicity, it will be said that the coils are attached to the body 105 here by means of their support. The shaft 110 is in one embodiment the shaft transmitting movement to at least one wheel of the motor vehicle, this shaft acting between the gearbox and the rear axle of the vehicle.

The casing 102, in one embodiment, is fixed to the casing of the gearbox, as described in the document EP-A-0331559 (FIG. 3). In a variant the casing 102 is fixed to the casing of the rear axle or to the vehicle chassis. In a variant, the shaft 110 is distinct from this transmission shaft, being offset with respect to it. For example, a speed multiplier acts between the shaft 110 of the rotor 101 and this transmission shaft or a plate fixed to it. In a variant, the speed multiplier acts between the shaft 110 and a shaft of the gearbox, for example for mounting the retarder of the hydrodynamic type with turbine wheel and impeller wheel.

The speed multiplier is for example produced in the form of a gear train comprising at least two toothed wheels. These wheels can be of the conical type so that the shaft 110 can be parallel to the transmission shaft or perpendicular thereto. In a variant, the speed multiplier is of the belt or chain type. The speed multiplier makes it possible to reduce the size and weight of the retarder. The heat exchange surface of the retarder is therefore reduced. For this reason, it is necessary to cool the electromagnetic retarder well so that it keeps good performance. In general terms, the coils heat up when they are supplied electrically so that it is necessary to cool them effectively.

This cooling is achieved as described below by virtue of the blades 140-142 and the apertures 120-123, making it possible to maintain a precise air gap between the stator 170 and the rotor 101.

The blades 140-142 and the apertures 120-123 belong to a ventilation device for cooling well the heads 103-104 of the coils that the stator 131 and the rotor 130 have in the aforementioned manner. More precisely, the rotor 130 comprises a body in the form of a packet of metal sheets having grooves, here of the semi-closed type, for mounting coils and forming an armature of the three-phase type or in a variant hexaphase. The coils of the rotor 130 have heads 108, 109 extending on each side of the body of the rotor 130. The stator 131 has arms projecting radially with respect to a body in the form of a packet of metal sheets. The coils of the stator are wound around the arms of the stator 131 with the interposing of an insulating support. The coils of the stator 131 therefore have heads 106, 107 extending axially on each side of the arms.

The ventilation device 140-142, 120-213 makes it possible to cool well the heads 103, 104, 106 to 109 of the coils in the aforementioned manner. The blades 140-142 belong to fans in the manner described below.

The coils with the heads 103 and 104 have an axis oriented radially with respect to an axis of the shaft 110. The coils attached to the body 105 therefore create a magnetic field oriented mainly radially with respect to the axis. In addition, this magnetic field loops back, passing through a pair of coils. This is because the magnetic field is formed by travelling through a core of the first coil and then enters the rotor 101 after having passed over an air gap. Next the magnetic field propagates in the rotor 108 and rejoins the core of the second coil, passing through the air gap. Finally, the field ends its loop by once again rejoining the core of the first coil. By passing through the stator 170, this magnetic field causes a creation of eddy currents that have a tendency to heat the stator 170.

This stator 170 surrounds the rotor 101 and comprises, in this example, at its external periphery, an axially oriented annular wall hollowed out by cooling chambers 111 and 112. These cooling chambers 111 and 112 have at least one large extension and one -small extension, the large extension being oriented parallel to the shaft. These chambers 111 and 112 are here hollowed out in the stator 170 of the retarder and have an annular shape. In a variant, these chambers have a shape in the form of a X, a Y or a Z and are hollowed out partially in the stator. These chambers 111 and 112 can even comprise an internal cover independent of the stator 170. This cover hermetically closes a wall of the partially hollowed-out stator. The object of these cooling chambers 111 and 112 is to cool the stator 170 by providing an exchange of heat between its hot walls and a cold cooling liquid circulating in these chambers 111 and 112. These chambers 111 and 112 can be added to a wall of the retarder that is not hollowed out.

The chambers 111 and 112 are located here radially above respectively the stator 131 and the rotor 101, the cooling liquid being for example the cooling liquid of the vehicle engine. The chambers 111 and 112 have an inlet and outlet for providing a circulation of the cooling liquid.

As for the blades 140-142, the object of these is to create currents of suction 179 and discharge 180-182 air. These currents of air 179-182 circulate inside the casing 102 and cool in particular the heads 103, 104, 106-109 of the coils. The current of suction air 179 corresponds to a suction of air arriving on the blades 140-142 and entering inside the retarder 100. The currents of discharge air 180-182 correspond to a discharge of an air flow leaving the blades 140-142 and emerging from the retarder 100 again. The blades 140-142 are conformed in order to put air in movement when the shaft 110 starts to rotate.

The blades 140 are attached to the rotor 101 of the retarder. The blades 141 are attached to the shaft 110. The blades 141 are attached to the shaft 110. The blades 142 are attached to the rotor 130 of the generator. More precisely, the blades 140 and 141 are respectively attached to the body 105 of the rotor 101 and to the shaft 110. This is because the blades 140 are located close to the heads 103 and 104 of the coils and in particular the head 103 of the coil. The blades 140 are located between this head 103 and the shaft 110 of the retarder 10. The blades 140 can be separated from the body 105 or be integrated in this body 104. The blades 141 are attached to the shaft 110 by means of a support 150. The blades 141 can be integrated in the shaft 110 or be attached and then secured to the shaft 110. The blades 142 are attached in a similar manner to that of the blades 140 to the body of the rotor 130 of the generator. In a variant, the blades 140-142 can be attached at different points on the rotor 101 to the shaft 110 or be directly attached to one of the heads 103 or 104 of the coil.

More precisely, the blades 140-142 each belong to a fan. As can be seen in FIG. 1, the blades 142 are secured to a flange, fixed here to the shaft 110 and its internal periphery, or in a variant to the axial end of the rotor 130 furthest away from the rotor 101. This fixing of the flange to the rotor 130 is achieved for example by spot welding, or in a variant by riveting, screwing or other fixing method. The flange is for example metal so that the blades are obtained by cropping and bending from their flange. In a variant, the blades 142 are moulded onto their flange. The blades 142 are located radially below the heads 108 in order to cool them properly.

The coils of the rotor 130 are formed by winding electric wires made from magnetic material, such as copper, around a core.

In a variant, in order to increase the power of the retarder, the coils are replaced by a network of electrical conductors in the shape of hairpins. These hairpins, roughly in a U shape, have heads extending outside the body of the rotor 130 and feet extending also outside the body of the rotor 130. These feet are welded alternately in order to form phases. The arms of the hairpins pass through the notches in the body of the rotor 130. For more information, reference can be made to the document WO-02/069472. In this case, the heads of the hairpins belong to the heads 108 and the feet to the head 109. The heads 108 are well cooled by the blades 142. The feet are advantageously fixed by welding of the laser type.

The blades 141 are secured to the support 150 constituting the flange of the fan carrying the blades 141. The blades 141 are obtained by cropping and bending from the flange 150 or in a variant are moulded onto the said flange. This flange 150 is fixed for example by a welding bead at its internal periphery to the shaft 110. The blades 141 are located radially below the heads 104 of the coils of the rotor 101 in order to cool these properly. The blades 140 belong to a fan advantageously obtained by moulding. The blades 140 are secured to a profiled base fixed for example by welding, here to the shaft 110 or in a variant to the body 105. The blades 140 are located radially below the heads 103. In a variant, the blades 140 and 142 are obtained by moulding with their flange.

The blades can be distributed in a variant individually on the flange, the shaft 110, the base and/or the rotors 101, 130. These blades in a variant issue from one of the rotors or from the shaft. In all cases, there is provided inside the casing at least one internal fan and the flanges constitute frames. Moreover, in order to ensure the passage of the air inside the retarder 100, the apertures 120-123 have different functions. In FIG. 1, a single aperture 120 and a single aperture 121, 122 and 123 can be seen. In reality, there exist a plurality of apertures 120 to 123 distributed advantageously in a regular manner so that the description that follows is given for only one of these apertures 120 to 123, which have different functions.

This is because the aperture 120 is an inlet aperture allowing an entry of the current of suction air 179 created by the blades 140-143. This current of air 179 enters parallel to the axis of the shaft 110. The apertures 120-123 are discharge apertures enabling the currents of discharge air 180-182 to leave. The currents 180-182 of discharge air can leave the retarder 100 either parallel to the axis of the shaft 110 or perpendicular or inclined with respect to the axis of the shaft 110, as in FIG. 1.

In order to ensure an entry of the current 179 of suction air parallel to the axis of the shaft 110, the inlet aperture 120 is produced in a part of the wall of the casing 102 oriented radially with respect to the axis of the shaft 110. In order to ensure a discharge of the currents 180-182 of discharge air perpendicularly or in an inclined manner with respect to the axis of shaft 110, the discharge apertures 121-123 are produced in a part of the wall of the stator 170 oriented parallel to the axis of the shaft 110, that is to say the peripheral wall of the casing 102 constituting here the stator 170.

These discharge apertures 121-123 are moreover produced in the wall of the stator 170 between cooling chambers. These apertures 121-123 are for example produced between the two cooling chambers 111 and 112. These discharge apertures 121-123 can also simply juxtapose a single cooling chamber 111. The discharge apertures can also be offset with respect to the cooling chambers. In a variant, these apertures 121-123 are produced in parts of the retarder that comprise no cooling chamber. In this variant, the apertures are therefore external to the cooling chambers. In another variant, in order to ensure a discharge of the current of air 179 parallel to the axis of the shaft 110, the discharge apertures 121-123 can be produced like the inlet apertures 120, in a part of the wall of the casing 102 oriented radially with respect to the axis of the shaft 110, that is to say in the radial rim. In this case, this part is situated at an end opposite to that where the inlet apertures 120 were produced.

With the configurations of the apertures 120-123 described above, the currents 180-182 of discharge air leaving through the apertures 121-123 can respectively come into contact with the heads 103 and 104 of the coils of the rotor 101. When there is contact with the heads 103 and 104, a heat exchange occurs between the air and these heads 103 and 104. The currents of air 180 and 181 can thus take heat from the coils in order to discharge it to an environment external to the retarder 100. A heat exchange can also be observed between the currents of air 180 and 182 and the heads 106-109 of the coils of the stator 131 and of the rotor 130 of the generator. Moreover, unlike the retarders of the prior art with no inlet and discharge apertures, the retarder according to the invention, with its configurations of apertures 120-123, makes it possible to create currents of air 180-182 with high flow rates that optimise the cooling of the retarder 100. In addition, the flows of these currents exhibit pressure drops that are reduced and directed.

In addition to the flow rates of the currents of air 180-182, the path of these currents of air 180-182 also has an influence on the efficacy of cooling of the coils of the retarder 100. This is because, the more a current of air has a path that brings it close to the heads 103 and 104 of the coil, the more it discharges the heat.

Thus, in order to impart a certain path to a current of air, it is possible to use blades of various types that have different shapes. In the example embodiment of FIG. 1, the blades 140 and 142 are blades of the centrifugal type, also referred to as centrifugal blades, whilst the blades 140 are of the helico-centrifugal type. The blades 141 and 142 extend horizontally, projecting with respect to the rotor 130 and to its base 150 or to a flange. The centrifugal blades 141 and 142 create a current of suction air 179 parallel to the axis and currents of discharge air 181 and 182 perpendicular to an axis of the shaft 110.

The blades 140 create the current of suction air 179 parallel to the axis and create an oblique current of suction air 180 forming a non-zero angle with respect to a straight line perpendicular to the axis of the shaft 110. This oblique current of air 180 can thus flow over the heads 103 and 107 of the coils as closely as possible in order to cool them, before leaving through the discharge aperture 122. In practice, in the case of the use of helico-centrifugal blades 140, the aperture 122 can project above a coil head. This projection of the aperture 122, shown in broken lines in FIG. 1, makes it possible to discharge the majority of the current of air 180 outside the retarder, taking into account a diversion of this current of air.

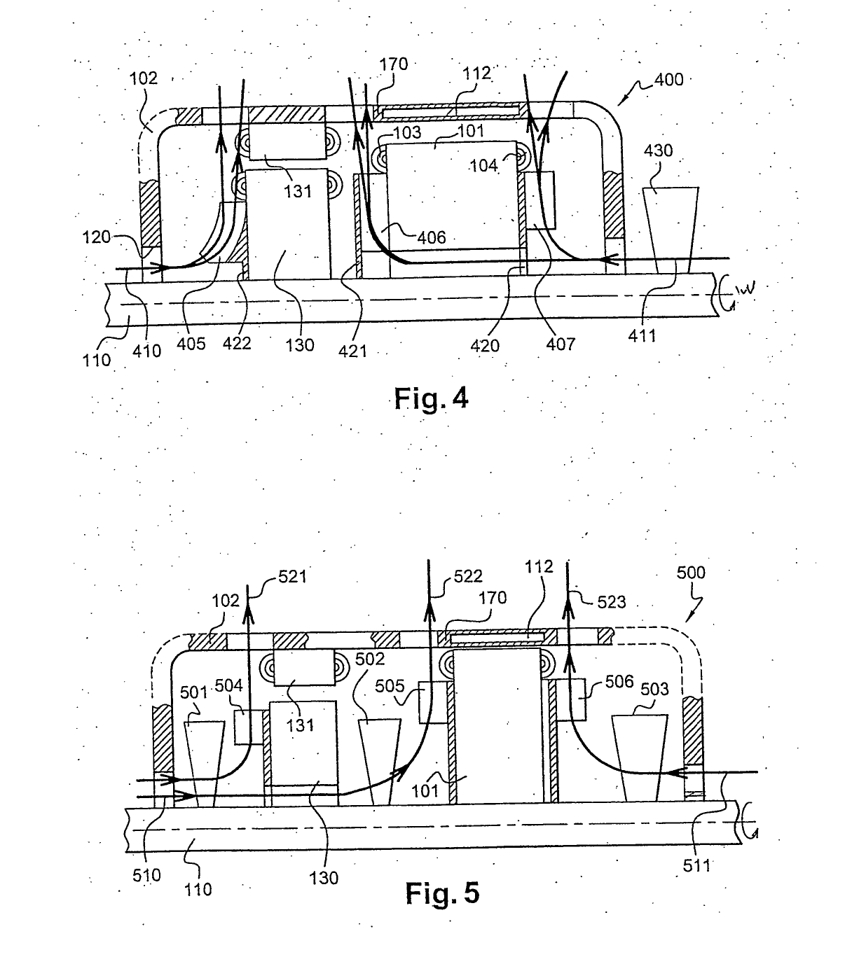

In addition, it is possible to use blades of the axial type, also referred to as axial blades, observable in FIGS. 4 and 5. These axial blades create a current of suction air parallel to the axis of the shaft 110 and a current of discharge air parallel to this shaft. Naturally it is possible to reverse the blades used in the retarder 100 with respect to each other and to add blades inside on the rotor 101. It will also be possible to add blades on the body 105 of this rotor 101 or on its shaft 110. The retarder 100 according to the invention can thus comprise a combination of centrifugal, helico-centrifugal and axial blades that are internal or external to the casing 102.

The rotor 101 of the retarder 100 and the rotor 130 of the generator of this retarder 100 can comprise openings 161 and 162 between the shaft 110 and the coil heads. Here the rotors 101 and 130 comprise openings in their base, that is to say at their internal periphery adjacent to the shaft 110. The rotor 101 and the rotor 102 thus have the current of air 170 pass through them. The current of air can then reach all the rotors of the retarder in order to cool them. By reaching all of the rotors of the retarder 100, this current of air 179 affords uniform cooling of all this retarder and in particular of all its coils.

In addition, the current of air 179 comes into contact with the internal wall of the rotors 101 and 130. The openings 161 and 162 in the base of the rotors 101 and 130 therefore make it possible to cool the coils of the rotor 101 by conduction. This is because the current 179 of air first of all cools the base of the rotor 101, which in its turn cools the body 105 of the rotor 101 and then the ends of this rotor 101 carrying the heads 103 and 104.

Like the rotors 101 and 130, the blades can also comprise an opening in their base in order to allow a current of air 179 to pass to another part of the retarder. Thus the blades 140 and. 142 have openings 163 and 164 in their base, that is to say in their flange, the profiled base supporting the blades 140 being extended internally by a flange intended to be fixed to the shaft 150, for example by welding.

The openings 161-164 in the blades 140 and 142 and the rotors 101 and 130 can be produced after they are manufactured by removing material from them. In one example embodiment, these openings 161-164 are produced when the blades are machined. In a variant, these openings are produced when the blades are moulded, using a mould having forms providing them.

FIG. 2 shows that the discharge aperture 122 can be produced through two cooling chambers 111 and 112. The chambers 111 and 112 in FIG. 1 are independent and each has its own cooling liquid supply. On the other hand, in this FIG. 2, the chambers 111 and 112 are connected in series and share a cooling liquid supply. These chambers 111 and 112 are also connected by a throttling throat 203 that allows passage of a cooling liquid such as the cooling liquid of the vehicle engine. In one configuration of the cooling chambers 111 and 112 connected in series, the apertures 201 and 202 are situated on each side of these chambers.

In a variant, the discharge apertures 201 and 202 can be produced between more than two cooling chambers 111 and 112 in series. In this variant, these chambers, greater than two in number, are connected together by several throttling throats 203. The cooling chambers 111 and 112 of the retarder 100 can also be connected in parallel and have a cooling liquid issuing from a single supply pass through them.

FIGS. 3a and 3b show currents of air 179, 301 and 302 that have different directions of suction from one retarder to another. These figures also show a particular form of inlet apertures 120 and outlet apertures 122.

FIG. 3a shows a retarder 100 comprising blades that create currents of suction air 179 having the same suction direction. FIG. 3a depicts in fact schematically the retarder 100 in FIG. 1 inside which the currents of suction air 179 enter on one and the same side of this retarder. These currents of air 179 thus pass through the entire length of the retarder 100 in the same direction. All the currents of discharge air are discharged through the discharge apertures 122 in a radial direction or a direction inclined with respect to an axis. In one example embodiment, a fan having a closed solid face is situated at the end of the retarder.

This fan prevents air from passing through it and discharges the current of air 179 through one end of the retarder.

Unlike FIG. 3a, FIG. 3b shows an electromagnetic retarder 101 comprising blades that create currents 301 and 302 of suction air having opposite directions with respect to each other. This opposition of the directions of the currents of air 301 and 302 can make it possible to increase air flow rates in zones situated in the centre of the retarder 101. This is because, in these central zones that are little ventilated, the parts have difficulty in being cooled and these parts therefore have a tendency to heat up a great deal. In these central zones, the two currents of air 301 and 302 coming from the two ends of the retarder 101 can meet each other and add to each other in order to provide effective discharge of the heat.

The internal fans carrying the blades can be oriented on one side or the other in the retarder 101. The direction of a current of air inside the retarder 101 can thus be modified by orienting the fans. These fans may be centrifugal or helico-centrifugal or axial. The arrows in dotted lines thus show an orientation of the currents of discharge air generated by fans comprising helico-centrifugal blades. These currents of air are slightly inclined with respect to a straight line perpendicular to the axis of the shaft 110.

In a variant, it is possible to use centripetal or helico-centripetal fans. The centripetal fan ensures the creation of a current of suction air that is roughly perpendicular, to within a few degrees, to an axis of the shaft 110 and the creation of a current of discharge air parallel to this axis. The helico-centripetal fan creates an oblique current of suction air forming a non-zero angle with respect to a straight line perpendicular to the axis of the shaft and a current of discharge air parallel to this axis.

The outlet apertures 122 are distributed on a wall of the retarder 100 or 101, so that the stator 170 and/or the casing 102 alternates a solid part and an open part. By alternating a solid part and an open part, the retarder 100 keeps a robust mechanical structure. The outlet apertures 122 can have overall the form of a rectangle whose sides follow the curvature of the casing 102. All the outlet apertures 122 can be grouped together on rings that describe an external periphery of the fan. The stator 170 and/or casing 102 then have a configuration that alternates with solid rings comprising no outlet apertures and rings comprising outlet apertures 122.

FIG. 3c shows a retarder 102 that comprises blades creating currents of suction air and currents of discharge air parallel to the axis. These currents of air propagate in the same direction. In the retarder 102, the inlet apertures 120 and outlet apertures 333 are produced in radial or inclined walls of a casing or of a stator, with respect to the shaft 110.

In a side view of the retarder 100, FIG. 3d shows the inlet apertures 120 produced in a casing or a stator. These apertures 120 are situated on a circle whose centre is merged with the centre of one end of the retarder 100. These inlet apertures 120 and the apertures 330 have roughly a trapezoidal shape with sides in the form of an arc of a circle. In a variant, the apertures 120 have another shape and are disposed not on a circle but in any manner. A housing 330 is provided for accepting a bearing that, in the aforementioned manner, supports the shaft 110.

The inlet and outlet apertures 120 and 122 can be produced in the stator 170 of a retarder 100. In practice, these apertures 120 and 122 can be produced or pierced in a retarder casing that can be independent of the stator 170 comprising a water circuit. The apertures 120 and 122 can also be produced in any other attached part having the role of closing and/or protecting the retarder 100.

FIG. 4 shows a schematic representation of a retarder 400 that is a variant embodiment of the retarder 100 according to the invention. The retarder 400 still has a rotor 101 and a generator comprising a generator stator 131 and a generator rotor 130. However, unlike FIG. 1, the retarder 400 has a configuration of fans comprising centrifugal or helico-centrifugal blades 405-407 that ensure the creation of currents of air 410 and 411 having opposite directions of suction with respect to each other.

Moreover, the rotor 101 and the blades 407 fixed to its body have holes in its face or internal periphery for cooling the heads 103 and 104 of coils installed on its two ends. The openings of the internal periphery of the rotor 130 (the base thereof) are unnecessary. Frames 420-422 or blade arms can be either integrated in the rotor 101 or 130, or external and independent of this rotor 101 or 130.

The blades 406 for example are secured to a flange constituting a frame 421 fixed to the shaft 110, for example by welding. The frame 421 is distant from the rotor 101 and is solid so that the air current is channelled. The blades 407 are fixed to a flange constituting the frame 420 fixed to the shaft 110 in the same way as the frame 421. The frame 420 has at its internal periphery openings for the current of air to pass.

The blades 405 have a form similar to the blades 140 in FIG. 1 and are therefore secured to a profiled base extended at its internal periphery by a flange for fixing to the shaft 110. This fixing is achieved in the same way as that of the frames 420, 421, the base and the flange of the blades 405 constituting the frame 422, here solid.

Compared with FIG. 1, the position of the fans and the direction of the blades have been reversed. This is because, in FIG. 1, the blades 141 and 142 are directed axially in the direction of the apertures 120, whilst in FIG. 4 the blades 406 and 407 are directed axially in the opposite direction with respect to the apertures 120. The free end of the blades 406 is in one embodiment fixed for example by adhesive bonding to the rotor 101.

The retarder 400 also has axial blades 430 external to the housing formed by the casing 102 of the retarder 400. These blades 430 have a profile roughly in the form of a truncated triangle and provide the creation of a current of suction air parallel to an axis of the shaft 110. The profile of the blades 430 is also here very close to a trapezium. These blades are secured to the shaft 110.

FIG. 5 depicts schematically a retarder 500 according to the invention that is another variant of the retarder 100. This retarder 500 still has a rotor 101, a stator 170 and a generator with a generator rotor 130 and a generator stator 131. As with FIG. 4, the directions of the suction air currents are opposed to each other. However, in this embodiment, the rotor 101 does not have an opening in its base and the rotor 130 of the generator does have an opening in its base. A base of the blade 501 also has an opening.

In addition, blades 501-506 fulfill a different function for allowing optimum penetration of the suction air currents 510 and 511 within the retarder 500 and optimum discharge of discharge air currents 521-523. To achieve this optimum penetration and discharge of air currents, combinations of two blades are situated between two consecutive rotors, at the entry to and exit from the retarder 500. These combinations of two blades can also be situated between a rotor 101 and a rotor 130 of a generator as in the figure. In these combinations, the blades 501-506 have a well defined role in order to separate a suction role and a discharge role. Thus, in practice, the axial blades 501-503 provide suction of a current of air 510 or 511 whilst the centrifugal or helico-centrifugal blades 504-506 provide a discharge of the air current. These combinations of blades 501-506 and this distribution of roles makes it possible to increase ten fold an effect of ventilation and cooling of the retarder 500.

The blades are secured to flanges in the aforementioned manner, the flanges or frames of the blades 501 being provided with openings in order to channel the current of air.

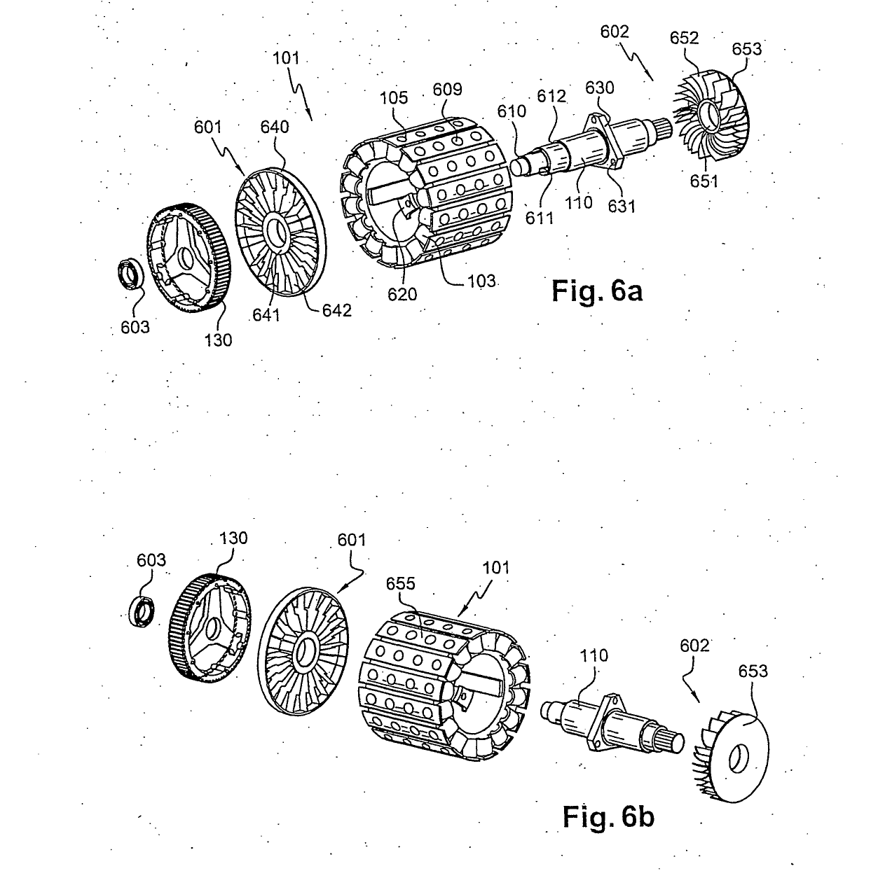

FIGS. 6a and 6b show views exploded in space of an assembly composed of a rotor 101, a generator rotor 130 and two fans 601 and 602. FIG. 6a shows in fact a front view of this assembly at an angle. 6b is a rear view of the assembly at an angle opposite to that at which the assembly in FIG. 6a is seen.

The rotor 101 with its coils comprising the heads 103 is fixed to its shaft 110. Two fans 601 and 602 are also attached to the shaft 110 on each side of the rotor 101. The rotor 130 of a generator and a bearing 603 are attached on the same side as the blades 601 to the shaft 110, that is to say mounted thereon.

The shaft 110 also comprises shoulders so that elements assembled on this shaft 110 can bear on the shaft 110 at different levels. In addition, the shaft 110 comprises a triangular support 630 to which the body 105 of the rotor 101 is fixed by means of bases 620, here in the form of lugs, which extend in radial projection with respect to the axis 110. These bases 620 have holes that, at the time of assembly, align with holes 631 produced in the three tops of the support 630 of the shaft 110 by means of aligned holes, the bases and the support 630. Fixing elements such as screws or bolts provide fixing between the body 105 of the rotor 101 and the shaft 110. A special fixing of the body 105 on the support 630 of the shaft 110 enables a current of air to infiltrate between the sides of the triangular support 630 and an internal periphery of the body 105 of the rotor 101.

The rotor 130 of the generator has centrally, for its part, the shape of a star with three arms. These arms have a contour in the form of a parabola allowing optimum passage of air between these arms and an internal periphery of the rotor 130 of the generator.

The external periphery of these arms is connected to the internal periphery of a ring constituting the body of the rotor 130 carrying the coils of the latter. The arms have a central opening provided with notches (not referenced) for cooperating with complementary projections 611 carried by the shaft 110 and to rotationally lock the rotor 130 on the shaft 110.

The projections are connected to a shoulder (not referenced) serving for the axial fixing of the central part of the rotor 130 and therefore of the latter on the shaft 110. The bearing 603 is fitted on the shaft 110 and is fixed axially by means of the shoulder 610 of the shaft 110. The fan 601 adjacent to the rotor 130 is fitted on a portion of the shaft 110 with a diameter greater than that of the portion used for mounting the rotor 101.

The fan 601 has a central ring 641 for fitting it on the aforementioned portion of the shaft 110. This portion is delimited by a shoulder 612 used for the axial fixing of the fan 601.

The fan 602, disposed on the other side of the rotor 101, also has a central ring 651 engaged on a portion of the shaft 110 and fixed thereon by means of a shoulder, not referenced. The end of the shaft 110 adjacent to the fan 602 is provided with flutes for mounting it in complementary flutes belonging to a toothed wheel. This toothed wheel belongs to a speed multiplier acting in the aforementioned manner between the shaft 110 and a transmission shaft or a secondary shaft of the gearbox.

The two fans 601 and 602 provide a creation of suction and discharge air currents. The fan 601 is of the axial type. This fan 601 has an annular external contour 640 and the internal ring 641 that comes into cooperation with the shaft 110 in the aforementioned manner.

Inclined blades 642 are distributed circularly in an irregular manner between the internal ring 641 and the external contour 640 of this fan. The blades 642 are inclined at a non-zero angle with respect to a plane that would pass through an axis of symmetry of the shaft 110. These blades 642 make it possible to put the air in movement when they start to rotate in order to create a suction air current parallel to the axis of the shaft 110. This current of air can pass over the rotor 130 and the blade 601 in order to enter and pass through a retarder inside which the rotor 101 is mounted over the entire length.

The fan 602 is a centrifugal fan that has blades of the same type. The fan 602 comprises an internal ring 651 but, unlike the blade 601, it does not have an annular external contour. Blades 652 are connected to the internal ring 651 and to a support 653 in the form of an annulus, oriented radially with respect to the axis of the shaft 110. This support 653 is itself secured to the internal ring 651. The blades 652 are curved or bent in the same direction, so that the air is discharged in a radial direction with respect to an axis of the shaft 110. The support 653 and the ring 651 constitute the base of the fan 602 to which the blades are secured.

In order to come into cooperation with the shaft 110, these internal rings 641 and 651 can be smooth whilst the shaft has an associated portion provided with knurling for forcible mounting of the rings 641, 651 on the shaft 110. It is possible to provide other solutions with projections carried by one of the elements consisting of shaft 110 and rings 641, 631 and entering in a complementary manner the grooves carried by the other one of the elements consisting of ring 641, 651 and shaft 110.

FIG. 6b shows the fact that the support 653 of the fan 602 in the form of an annulus is solid. Thus the air cannot pass through the fan 602 and is driven in a radial direction. Consequently a current of air passes first of all inside the body 105 of the rotor 101 in length and is then discharged in the direction of the coil heads by means of the blades 652.

On one of its peripheries, the rotor 130 of the generator comprises coils or heads of leading-out wires distributed regularly. The generator stator is excited and creates a magnetic field in which the rotor turns. This magnetic field gives rise to an alternating current by induction. This alternating current is collected at the terminals of the rotor and rectified with the bridge. Next this current is sent to the retarder rotor.

Screws 609 fix the coils and their heads 103 so that these coils have their axis, passing through their two heads, oriented transversely with respect to the shaft 110. The magnetic field created by these coils is thus also oriented mainly transversely or radially with respect to the shaft 110. More precisely, with each coil there is associated a retaining bar 655 fixed by the screws to the core (not visible) around which the coil is wound.

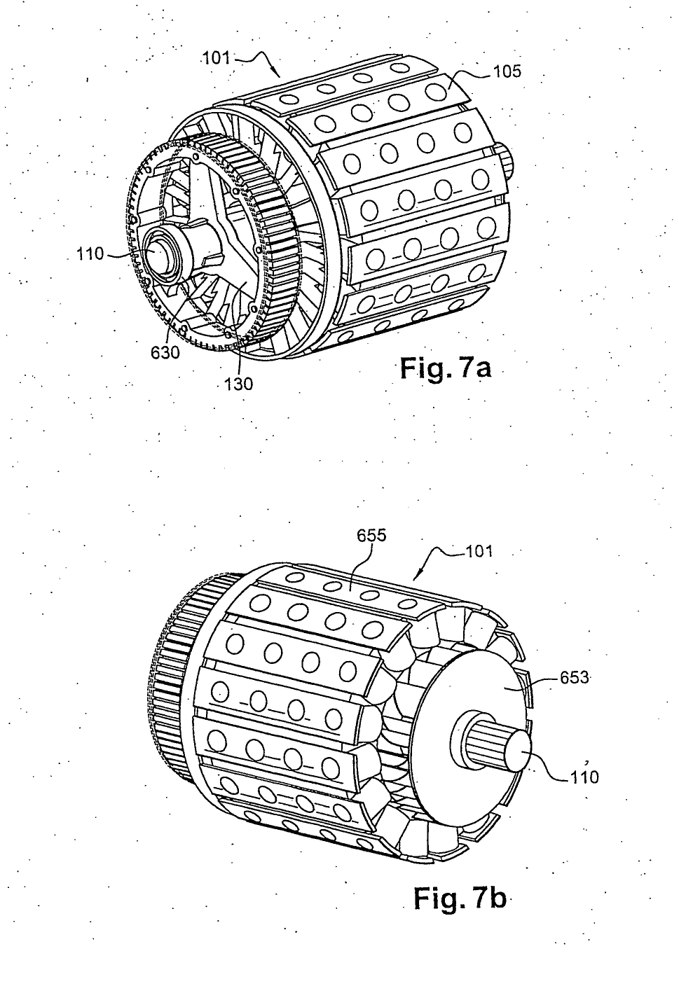

FIGS. 7a and 7b show an assembly of the rotor 101, the generator rotor 130 and fans 601 and 602. This assembly shows the many spaces that exist through the various assembled parts. Thus, in FIG. 7a, the shaft 110 and the coils of the body 105 can be perceived through the rotor 130 of the generator.

This remarkable assembly enables the currents of air to pass thoroughly inside the retarder in order to cool it effectively. This assembly with these spaces also makes the parts easily accessible inside the retarder. With such an assembly it even becomes possible to identify a certain fault in the retarder rapidly by looking inside through the spaces between parts.

Naturally, it would be possible to create even more spaces or openings in walls of the body 105 of the rotor. In one example it would be possible to create spaces between the coil heads 105 fixed to the body. These spaces would increase further a passage for the air inside the rotor 101.

FIG. 7b shows that the back of the assembly between the rotor 101, the rotor 130 and the blades 601 and 602 does not have any opening. This is because the fan 602 closes the assembly. In this example embodiment, the fan 602 is fixed to one end of the shaft 110 of the rotor 101 and then in some way fulfils the role of an air discharge plug. In a variant, the fan 653 comprises an open support that has spaces between its blades, and then becomes axial.

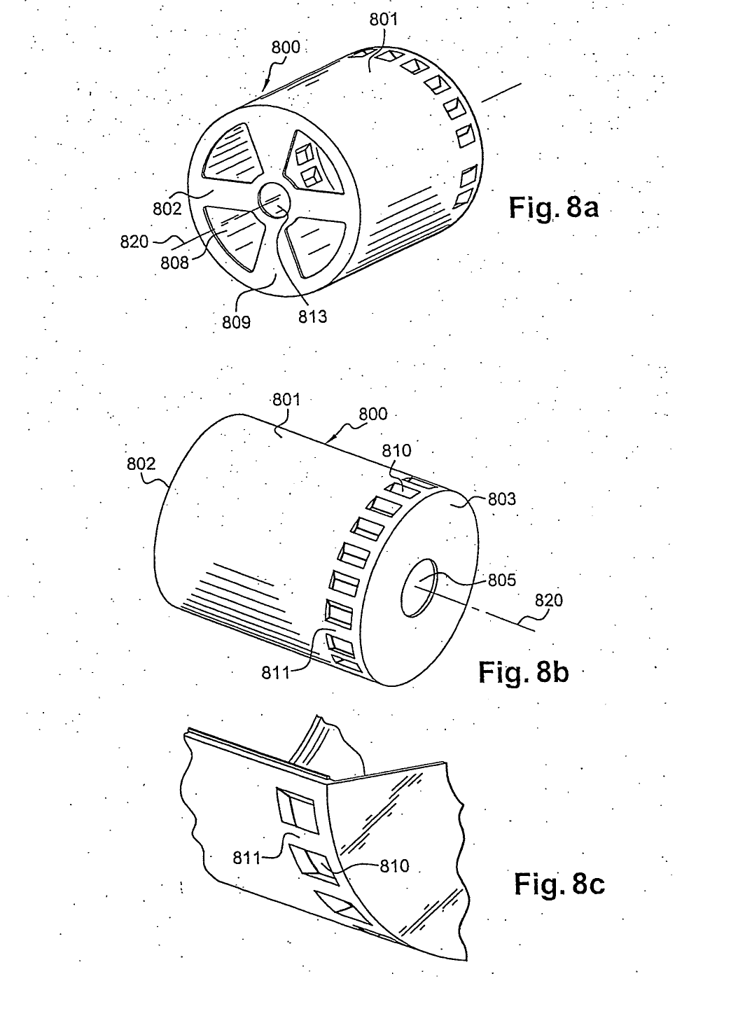

FIGS. 8a, 8b, 8c show a retarder casing seen in space. This is because these figures show views of the casing 800 at different angles. This casing 800 accepts the assembly composed of the rotor 101, the generator and the blades described previously. This casing 800 can surround the stator, referenced 170 in FIG. 1, and be an independent part thereof. But naturally the casing 800 can also be the stator with a water circuit travelling through it. This water circuit is not shown but could be integrated in the stator on an external contour of this stator. The casing 800 is tubular in shape.

FIG. 8a shows a side view of the casing 800. This casing 800 has a cylindrically-shaped central part 801. This central part 801, constituting the aforementioned peripheral wall, terminates in two radial ends 802 and 803 (FIGS. 8a and 8b). These ends comprise radial rims. At least one of these ends is added for introducing the rotor. In one example embodiment, the central part 801 can include or surround the stator. The ends 802 and 803 are attached with respect to the central part 801. The ends 802 and 803 comprise holes 805 and 813 enabling the shaft 110 to pass through the casing 800.

FIG. 8a shows a form of the end 802 comprising inlet apertures 808. These apertures 808 provide the passage of a suction air current in a direction parallel to the axis 820 of the casing 800. These inlet apertures 808 are separated from each other by arms 809, here four in number. As described previously, the apertures 808 have a shape roughly in a trapezium with slightly curved sides that follow a contour of the end 802. The purpose of the trapezium shape of the apertures 808 is to allow a current of air to pass optimally inside a retarder without for all that weakening the mechanical structure of the casing 800. In order to give the apertures 808 their trapezium shape, the arms 809 delimiting the apertures have rectangular or trapezoidal shapes. In the embodiment of the casing 800 in the figure, a rectangular-shaped arm 809 alternates with a trapezoidal-shaped arm 809.

An axial fan can be mounted on one side or the other of the radial end 802 in order to create a suction air current.

The end 802 is here moulded with the central part 801 of the casing 800. However, this end 802 could be an attached piece that is screwed onto or fits into the part 801.

FIG. 8b shows the casing 800 at an angle opposite to that at which it is shown in FIG. 8a. This is because FIG. 8b shows the other end 803, which has discharge apertures 810 on its external periphery. This end 803 is situated around a centrifugal or helico-centrifugal fan and in fact discharge apertures 810 allow a discharge of an air current created by such a fan. Between two discharge apertures 810, the end 803 has inclined fins 811. As the fins 811 form contours of the apertures 810, these apertures 810 are also inclined.

FIG. 8c also show an enlarged view of these fins 811. These fins 811 make it possible firstly to hold the mechanical structure of the casing 800 and on the other hand to discharge an air current in an optimum fashion. This is because, in a particular embodiment, a profile of the fins 811 is tapered and has a very limited obstacle for the air current passing over them. These fins 811 also have an inclination in the direction of rotation of the fan facing which they are situated. More precisely, these fins 811 are inclined at an angle corresponding to an angle of a fluid feed, here air, inside the casing 800. Moreover, in addition to being oriented in a particular manner, these fins 811 are very fine in order to limit the obstacle that they present with respect to an air current.

Thus, as the fins 811 are oriented and fine, an angle of incidence of the air on these fins is almost zero. In other words, for a given air flow, there is no angle of incidence on the obstacle consisting here of the fin 811. The particular profile of the fins therefore greatly reduces a wake in the air. By reducing this wake in the air, this particular inclination reduces the noise of the fan and gives a pressure drop of molecules of the air. In a variant, these fins 811 could have a completely aerodynamic profile, like the profile of an aircraft wing for example. However, even if the aerodynamic effect is less, the fins could also be oriented solely radially. Like the end 802, the end 803 can be moulded with the part 801 in the same piece. The end 803 can also consist of the attached piece that is screwed, welded or fitted onto the casing 800.

In another embodiment using a retarder comprising axial blades situated at its two ends, the casing 800 has two ends 802 at its two extremities, see FIG. 8d. The discharge apertures are then produced in a part of the wall of the casing oriented transversely with respect to the axis of the rotor shaft. In one example, a discharge aperture is produced between a cooling chamber and the shaft. The air can then pass through and cool the retarder with an air current traversing the stator or casing 800 in a direction parallel to the axis.

In another embodiment, the retarder according to the invention comprises centrifugal or helico-centrifugal fans. The casing 800 then comprises several rows 810 for discharging the discharge air currents created by these fans.

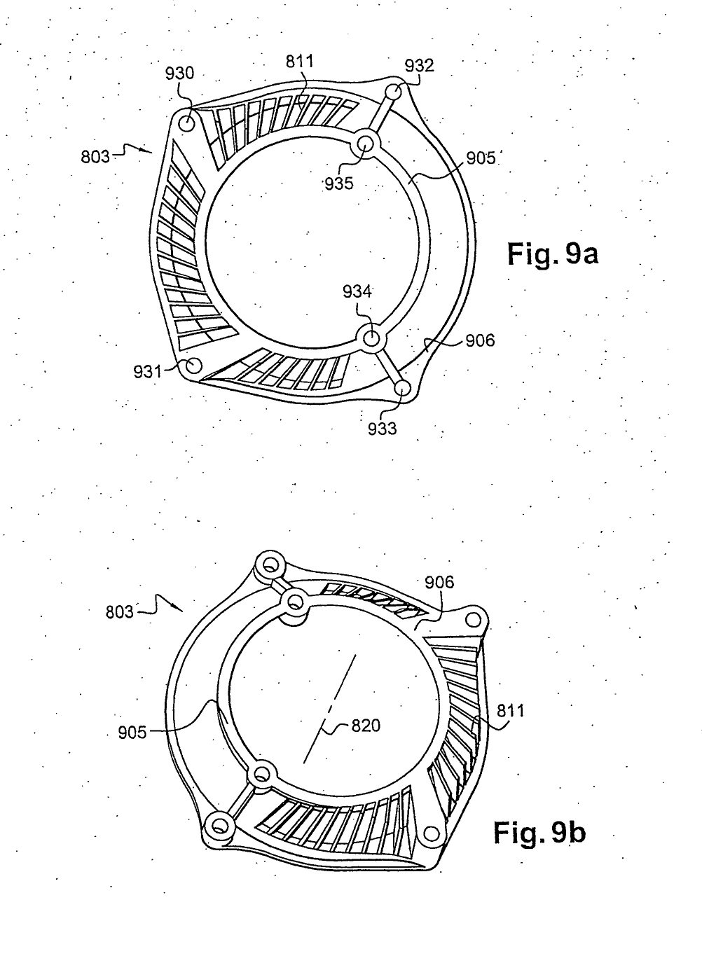

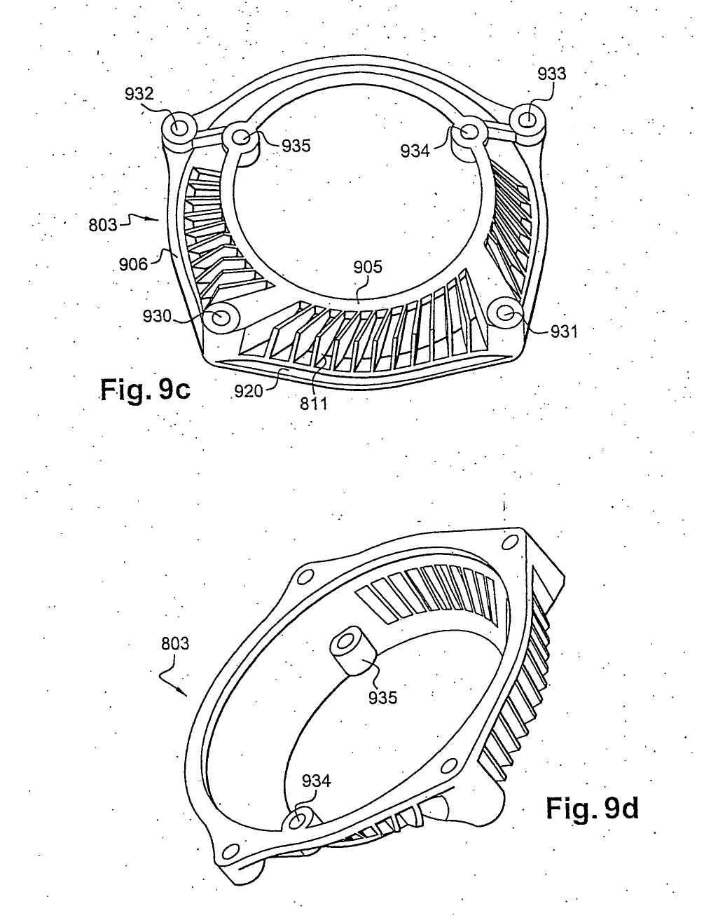

FIGS. 9a, 9b, 9c and 9d show an isolated view of an independent end 803 of the casing 800. This end 803 surrounds a centrifugal or helico-centrifugal fan. This end 803 is screwed onto the central part 801 of the casing 800 by means of screws entering holes 930-935. In a variant, this end 803 does not have holes 930-935 and is welded onto a contour of the central part 801.

FIG. 9a shows clearly that the fins 811 are inclined in a direction of the air flow, that is to say in a direction of rotation of blades of a fan. The fins 811 form in fact an angle with respect to a radial plane passing through an axis of symmetry 820. The fins 811 are also included (extend) between an internal ring 905 and an external ring 906. The fins 811 are roughly parallel in pairs. The fins 811 are not located over an entire annulus described by these two rings 905 and 906. This is because this annulus comprises a solid part that is oriented towards the ground in a particular mounting of a retarder of a vehicle. This solid part thus protects the retarder from water splashing or any gravel due to a movement of the vehicle on a wet and/or damaged road.

FIG. 9b shows that the ring 906 and the ring 905 are situated on two parallel planes offset with respect to each other. The end 803 thus has a surface describing that of a truncated cone. The offsetting of the rings 905 and 906 involves an offsetting of the fins with respect to a plane parallel to a ring. This is because these fins 811 are connected by their two ends to the two rings 905 and 906. The fins 811 are therefore not only inclined in the direction of the air flow, as already seen, but also with respect to an axis of a shaft entering inside the casing 800. Defined by a space between two fins, the outlet apertures are therefore also inclined with respect to the axis of the shaft of the retarder.

FIG. 9c shows a plan view of the end 803 that shows a machined area 920 in this end 803. This machined area 920 is situated on one end of the fins 811. This machined area 920 is flat and is produced in the ring 906. This area 920 makes it possible to extend the termination of the fins 811 so that sides of the end 803 are pressed against the casing 800 over the largest possible surface area. The area 920 thus optimises an abutment between the end 803 and the central part 801 of the casing 800. Moreover, the area 920 has a sinuous shape in order to vary a size of the fins 811. This is because the fins 811 have a width that decreases in the direction of circular movement away in order to ensure a sufficient and effective flow of an air current.

The end 903 has fixing holes 930-935. The holes 930-935 are situated on the external periphery of the end 803, that is to say on the ring 906. The other two holes 932 and 933 are situated on the internal periphery of the end 803, that is to say on the ring 905. The holes 930 and 931 are produced in the parts that follow an orientation of the fins 911. The holes 932 and 933 are produced in a part of the end 803 opposite to the holes 930 and 931. The holes 934 and 935 are connected by their base to the fixing holes 932 and 933 situated on the internal ring of the end 803.

FIG. 9d shows that the holes 935 and 936 are produced on the bottom of the end in bases attached to the ring 905. These circular-shaped bases extend in radial projection with respect to an axis of symmetry of the end 803.

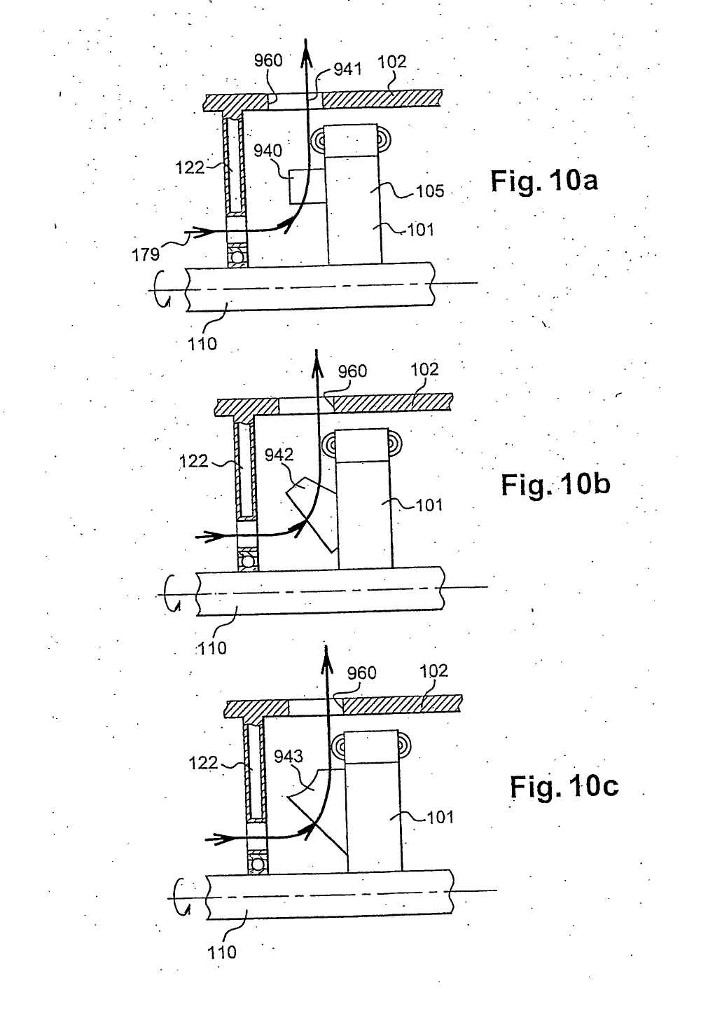

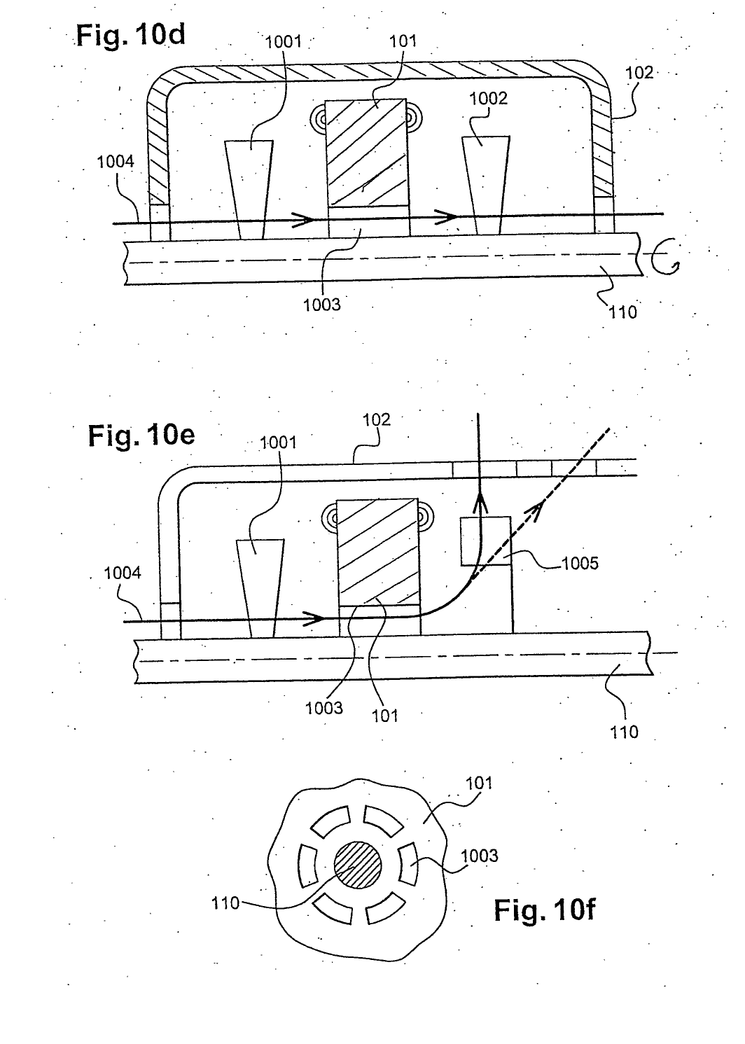

FIGS. 10 to 14 show variants of the retarder according to the invention with a rotor 101 carrying coils whose axis passing through their heads is oriented parallel to the axis of the shaft 110. The field generated by these coils propagates essentially parallel to the axis of the shaft 110. Such a retarder is often said to be an axial retarder.

For this retarder, the cooling chamber 122 is oriented transversely. This is because this cooling chamber has at least one large extension and one small extension. The large extension is oriented transversely to the shaft 110. The cooling chamber 122 is here hollowed out in the stator and has an annular shape. In a variant, the chamber 122 can be hollowed out partially in the stator and have another shape such as a Y shape, or a Z shape, or an X shape. The chamber 122 can be completely added to the stator 170. FIGS. 10a to 10c show retarders according to the invention comprising blades attached to the rotor 101. These blades are close to a coil head and a discharge aperture so that the air current can flow over the head and be discharged easily. These blades are attached to the body 105 of the rotor 101.

More precisely, in these figures, the body 105 of the stator 101 has a plurality of axially oriented cores, as described in the document FR-A-2577357, around each of which the coils are mounted with the intervention of a coil support made from insulating material. The cores are connected together by two flanges constituting pole enlargements attached to the axial ends of the cores. The flanges are secured to the shaft 110. For good heat exchange the flanges carry fins level with the cores and coils. These fins are allocated the same references as the heads of the coils of the rotor in FIG. 1, with the index provided since these fins are equivalent to the heads 103, 104 and constitute a variant embodiment of the heads.

In FIG. 10a, blades 940 create a suction air current 179 that enters the retarder and a discharge air current 941 that leaves the retarder through apertures 960. The blades 940 in FIG. 10a have a rectangular shape. These blades 940 provide a discharge of the air in a direction perpendicular to the shaft 110. These blades 940 are of the centrifugal type.

FIGS. 10b and 10c show retarders that are variants of FIG. 10a. This is because the blades 942 and 943 attached to the shaft of the rotor 101 always provide a discharge of the air in a direction roughly radial with respect to the shaft 110. Nevertheless, the blades 942 are helico-centrifugal blades. These blades 942 have a profile roughly in the form of a special quadrilateral. This quadrilateral has two almost parallel sides inclined with respect to a radial direction with respect to the axis of the shaft 110. The blades 942 are helico-centrifugal and the discharge air current that they create is inclined with respect to the shaft 110.

In FIG. 10c, the blades 943 have the form of an aileron. This is because these blades 943 have a straight side and a side that is curved in a concave or convex manner in order to improve the suction of an air current. These blades 943 have roughly the shape of a triangle, one base of which is fixed to the rotor or more precisely to the body of the rotor 101.

FIGS. 10d and 10e show blades or fans attached to the shaft 110 of the retarder according to the invention. This is because FIG. 10d shows a retarder comprising blades 1001 and 1002 of the axial type mounted on each side of the rotor 101. An opening 1003 is produced inside this rotor in order to facilitate the passage of air currents 1004 through the retarder. In a variant, only the blade 1001 is attached to the shaft 110, on one side of the rotor 110. In another variant, only the blade 1002 is attached to the shaft 110, on another side of the rotor 110. The blades 1001 and 1002 are for example secured to a central ring fixed to the shaft 110.

FIG. 10e shows a combination of blades 1001 of the axial type and blades 1005 of the centrifugal or helico-centrifugal type. The blades 1001 are mounted upstream of the blades 1005 with respect to a flow of an air current. The combination of these blades makes it possible to generate a suction air current parallel to the axis of the shaft 110 and a discharge air current inclined with respect to a perpendicular direction. The rotor 101 of the retarder also comprises openings 1003. Naturally, in these FIGS. 10d and 10e, only one opening 1003 can be seen, but in reality there exist several openings 1003 and also several blades 1001, 1002 and 1005 distributed circumferentially.

FIG. 10f also shows a view in section of a rotor 101 comprising openings 1003 allowing a passage of an air current. This rotor 101 also comprises a hole that allows the passage of the shaft 110. In general, the openings 1003 have a shape very similar to that of the inlet apertures that can be seen in FIG. 3d. This is because these openings 1003 have roughly the shape of a trapezium with sides curved in a curvature of a circle. In a variant, these openings 1003 produced in the rotor are of any shape such as roughly rectangular, round, oval or polygonal.

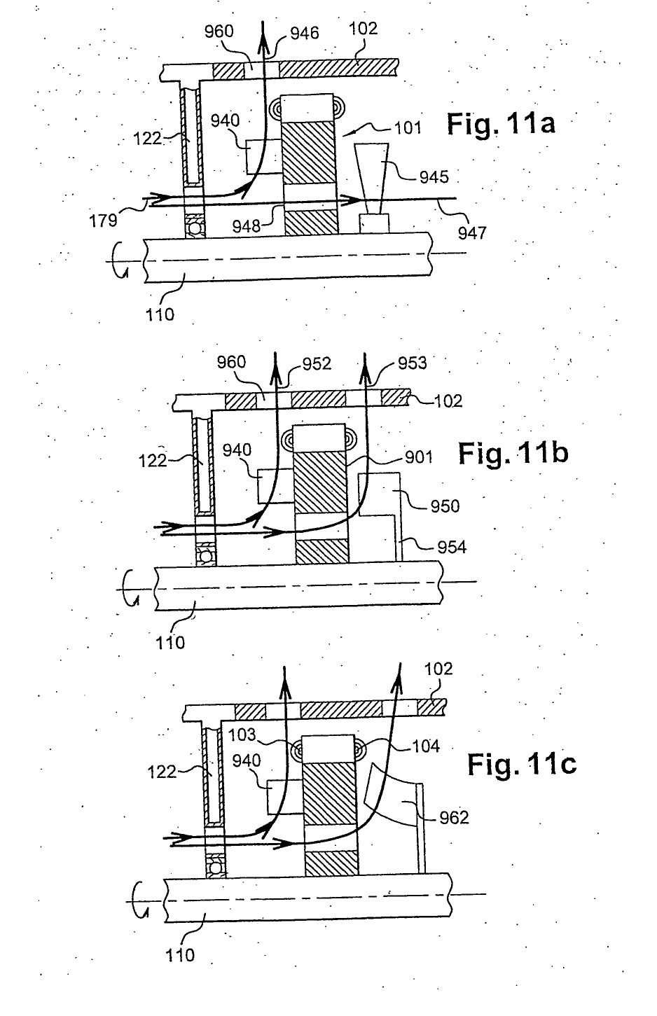

FIGS. 11a, 11b and 11c show retarders according to the invention still comprising cooling chambers 122 oriented radially with respect to the axis of the shaft 110.

However, these retarders each comprise two series of blades that enclose the rotor 101 in order to cool the coils of this rotor in an optimum fashion. A discharge air current that propagates radially with respect to the axis of the shaft 110 is discharged through discharge apertures 960 produced in walls roughly parallel to the shaft 110. This suction air flow that propagates parallel to the shaft 110 is discharged through discharge apertures oriented radially towards the axis of the shaft 110.

In FIG. 11a, the blades 940 are attached on one side of the rotor, to its body, whilst blades 945 are attached on the other side of this rotor. The blades 940 and the blades 945 create a suction air current 179. The blades 945 are connected to a central ring fixed to the shaft 110. The same applies to the blades 968, 969 described below.

The blades 945 are axial blades, and therefore the discharge air current that they create propagates in a direction parallel to the shaft 110. The blades 940, as in the previous figures, create a discharge air current that propagates in a direction perpendicular to the shaft 110. The rotor 101 is perforated or comprises an opening 949 in its base in order to provide the passage of the current 947 towards a discharge aperture.

In FIG. 11b, two series of blades 940 and 950 are situated on each side of the rotor 901. These two series of blades 940 and 950 provide the creation of discharge air currents 952 and 953 in a direction perpendicular to the shaft 110. These blades 940 and 950 are blades of the centrifugal or helico-centrifugal type. The blades 950 are attached to the shaft 110 of the rotor 101. These blades 950 have a rectangular shape and a base 954 that connects it to the shaft 110. The base 954 of the blades 950 is solid, like the support 653, in order to prevent the propagation of an air current along the shaft. The blades 950 are centrifugal.

FIG. 11c shows a retarder that is a variant of the retarder depicted in FIG. 11b. This is because blades 962 of the helico-centrifugal type are situated in place of the blades 950. These blades 962 comprise roughly the shape of a trapezium with sides that are rounded in shape. The discharge air current created by the blades 962 are inclined with respect to the shaft 110.

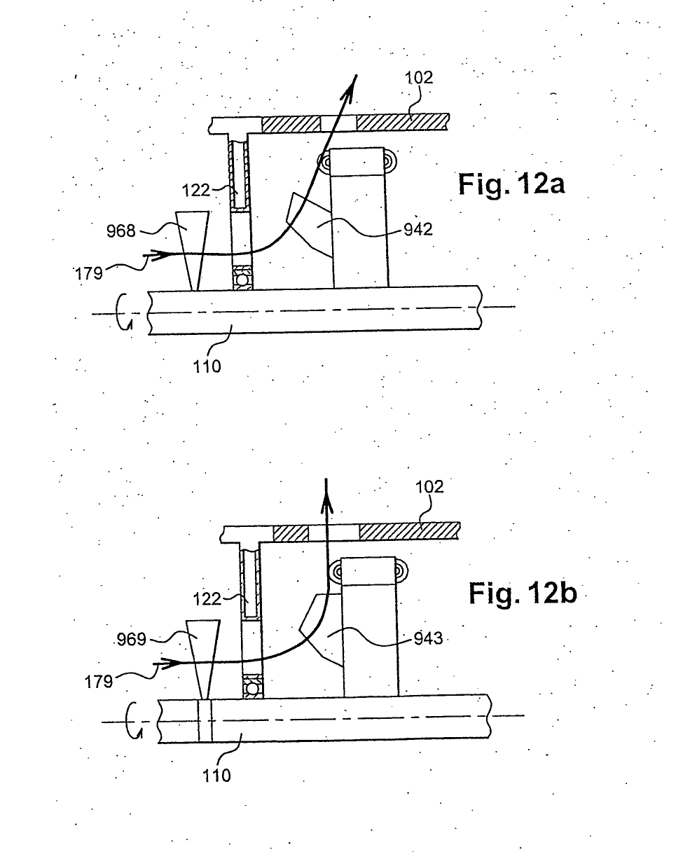

FIGS. 12a and 12b show a retarder according to the invention comprising blades situated on each side of a cooling chamber 122. In the two embodiments, the axial blades 968 and 969 are attached at the inlet of the retarder in order to create a suction air current 179. The blades 968 and 969 are for example secured to a central ring fixed to the shaft 110. Blades 942 and 943 are attached to the body of a rotor that can be that of a retarder or that of a generator of this retarder. These two blades provide the discharge of an air current in a different manner.

In FIG. 12a, the blades 942 having the same shape as those in FIG. 10b are helico-centrifugal blades. These blades 942 provide a discharge of an air current in a direction slightly inclined with respect to the vertical or to a direction radial to the shaft 110.

In FIG. 12b, the blades 943 that could be observed in FIG. 10c provide a discharge of the air current in a direction perpendicular to the shaft 110.

By thus using a combination of blades 968 and 942 or 969 and 943, it is possible to increase a flow rate of the air currents for travelling inside the retarder.

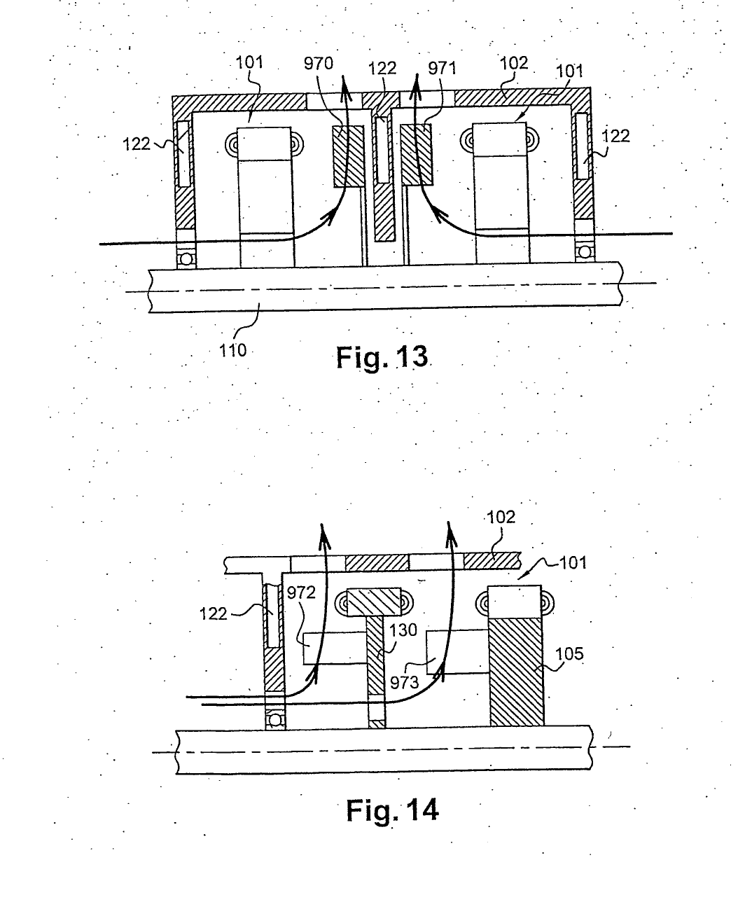

FIG. 13 shows a retarder comprising two series of blades 970 and 971 mounted on each side of the cooling chamber 122. The particularity of this mounting lies in the fact that the blades 970 and 971 are mounted back to back with respect to each other. These two blades 970 and 971 thus allow the creation of two independent and opposite air currents providing the cooling of the coils of a rotor. These blades 970 and 971 are solid, so as to guide an air current towards a discharge aperture. Here the two series of blades 970 and 971 used are centrifugal blades but, in a variant, it would be possible to use helico-centrifugal blades. In this figure two rotors 101 are provided.

FIG. 14 shows a retarder according to the invention comprising coils oriented axially and provided with blades 972 and 973 located in a very similar manner to what can be seen in FIG. 1. This is because these blades 972 and 973, of the centrifugal or helico-centrifugal type, are respectively installed on the body of a rotor 130 and on a body of the rotor 105. The rotor 130 of the generator has an opening in its base in order to allow an air current to pass to the rotor 105. However, unlike FIG. 1, the rotor 105 does not have an opening in its base.

In FIGS. 11a to 14 the field generated by the coils can be of the axial or radial type. For reasons of simplicity the current generator has not been shown and the same applies in FIGS. 10a to 10e. This current generator is for example installed to the right of the rotor 101, unlike the embodiment in FIG. 1 where it is installed to the left of the rotor 101. In FIGS. 10a to 13, the generator is installed outside the casing 102, its stator being carried by the casing.

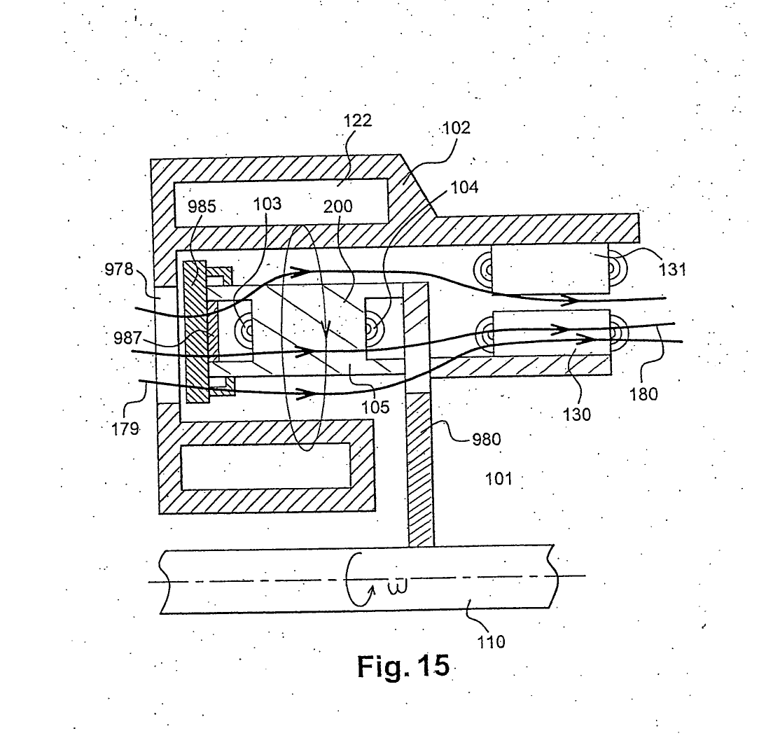

FIG. 15 shows a retarder according to the invention comprising a rotor 101 and a stator 102. The rotor 101 is connected to the shaft 110 by means of an annular flange 980 made from non-magnetic material. This flange 980 is fixed for example by means of screws to a triangular support of the shaft 110 as in FIGS. 6a and 6b. The flange carries a sleeve made from non-magnetic material carrying the inducing rotor 130. The rotors 101 and 130 are situated on each side of the flange 980.

As with the retarder in FIG. 1, the coils having the heads 103 and 104 are oriented radially with respect to an axis of the shaft 110 and the chambers axially. The difference in structure compared with the retarder in FIG. 1 lies in the fact that here the coils, having the heads 103 and 104, of the rotor 101 extend in axial projection with respect to the flange 980; and in the fact that the cooling chambers 122 are situated on each side of the body of the rotor 105, so as to enclose this rotor. The stator comprises two parts that work mechanically at the same time. These two parts facilitate cooling of the stator. The body 105 of the rotor therefore enters an annular cavity delimited by the two parts of the stator working at the same time in order to slow down, that is to say to brake, the movement of the shaft 110.

In this retarder, an inlet aperture 978 is produced in a part of the wall of the retarder connecting together the two parts of the stator and the two cooling chambers 122. This part of the wall of the retarder is oriented transversely with respect to the shaft of the rotor 101. The two chambers are axially oriented and are connected by a radially oriented bottom. More precisely, the chambers can be hollowed out in external and internal concentric walls connected by a radial bottom. This bottom can carry a chamber that connects the two chambers together. Inlet and discharge apertures can pass through this bottom.

In this figure, blades 985 are attached to or close to the head of the coil 103. These blades 985 allow the creation of air currents 179 and 180 that enter through the inlet aperture 978 and leave through a space existing between the rotor 130 and the stator 131 of the generator. These air currents thus pass through the space between the two parts of the stator 102 and come into contact with the heads of coils 103 and 104 located in the rotor 101. The blades 985 are axial and therefore the air currents propagate parallel to the axis of the rotor 101. Openings are produced in the flange 980.

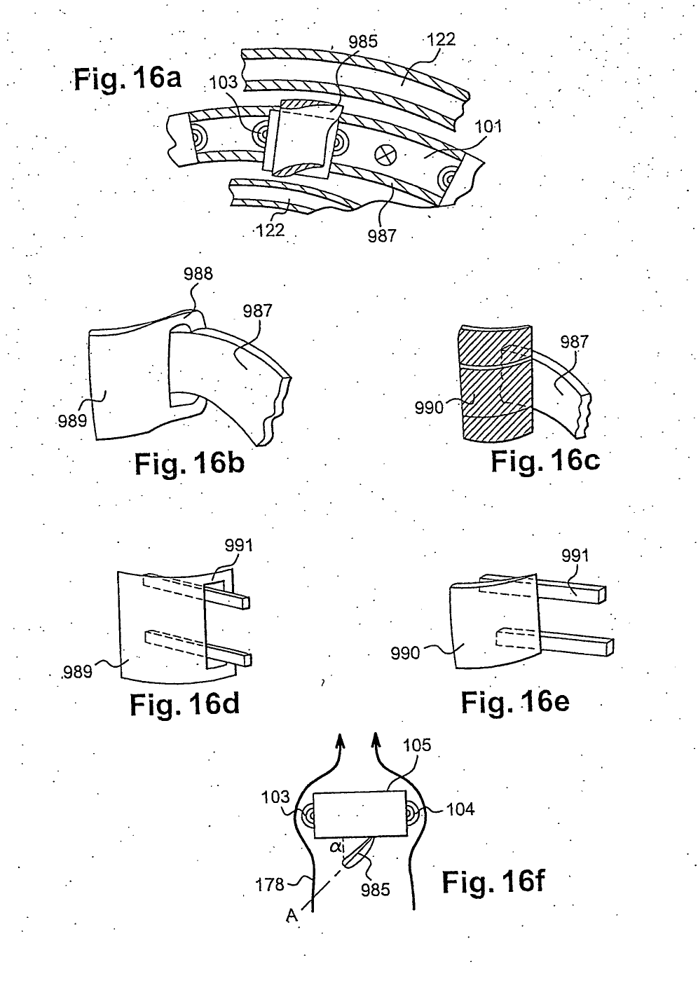

FIGS. 16a-16f show examples of the fixing of axial blades 985 to a ring 987 fixing the rotor 101. This ring is intended to fix the coils comprising heads 103. This ring 987 is surrounded by cooling chambers 122. The blades 985 are here mounted directly on the ring 987, for example in front of each coil or between each coil. The blades 985 are axial. The air circulates in a direction perpendicular to the plane of the figure. This air moves in a direction going from the blades 985 to the ring 987. In a variant, the blades 985 are attached to the heads 103 of the coils.

FIGS. 16b and 16c show a ring 987 produced in a single piece. FIG. 16b shows roughly rectangular blades 989 that have two elbowed arms 988. These arms 988 close up and are fixed to the ring 987.

FIG. 16c shows blades 990 that have a roughly rectangular shape with a length and a width. FIG. 16c shows blades 990 installed on the ring 987 over its entire length. In practice, the blades 990 are welded to the ring 987 but they could also be fitted in or screwed to this ring 987.

The ring 987 can be produced in a single piece as in FIGS. 16b and 16c or in two parts, such as rings, distinct from each other.

FIGS. 16d and 16e also show blades located on a ring 991 having two distinct annuli. These two annuli are separated from each other by a distance substantially equal to a width of the blades 985.

FIG. 16d shows the blades 989 with its two arms 988 each located on an annulus of the ring 987. FIG. 16e shows rectangular blades 990 that come into contact with the two annuli over the entire width. The ring 987 can also have openings or perforations for optimising the passage of air inside the rotor or retarder.

FIG. 16f shows a plan view of the blades 985 attached to the ring 987 or to a coil. These blades 985 have overall inclined directions forming an angle α with respect to a side of the body of the rotor 105 carrying the coil heads 103 and 104. These blades 985 create a current of air 178 in the direction of an arrow A that passes through the coils and their support. In addition, these blades make it possible, according to their inclination, to modulate an air flow and a direction of an air current according to the cooling desired.

More precisely, the cores 200 of the rotor 101 are in FIG. 15 separated from each other and attached to the flange 980. Each core 200 has at each of its axial ends shoes for mounting the heads 103 and 104. The shoes associated with the head 103 are connected together by the ring 987 on which the blades 985 are fixed. The ring in FIG. 15 is of the type in FIGS. 16b and 16c. In a variant, the ring 987 is replaced by two annuli 991 located at each shoe. The annuli 991 or the ring serve for fixing the blades and also for connecting together the cores 200 in order to hold them counter to the action exerted by the centrifugal force.

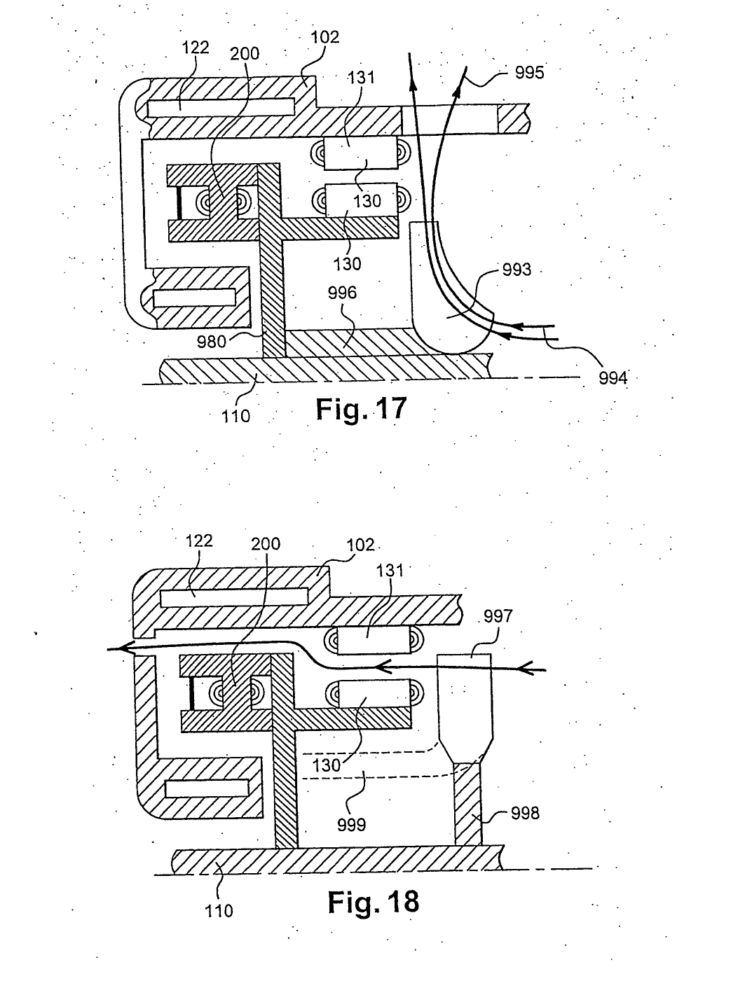

FIG. 17 shows centrifugal or helico-centrifugal blades 993 creating a suction air current 994 and a discharge air current 995. This discharge air current is parallel to or forms an angle with a direction radial to the shaft 110. With this particular direction, the air current can flow over the generator coil heads. This is because the blades 993 make it possible to cool the heads of the coils of the generator rotor and stator.

The blades 993 have a profile roughly in the shape of a bicycle saddle. Two sides of each of the blades 993 form an angle at 90° and the other two have curved shapes. One side has a concave shape, the other a convex shape. The convex shape is attached to the rotor by means of an arm 996 so that the blades 993 are situated facing the heads of the coils of the generator 130 and are possibly attached to the shaft.

FIG. 18 shows a variant of FIG. 15 in which a suction direction is opposite to that of the air current in FIG. 15. This is because the air enters a space between the stator and the rotor of the generator in order to emerge through an aperture produced in a wall of the stator 101. The support 980 can have orifices allowing a passage of air currents. Axial blades 997, roughly rectangular in shape, create this air current. More precisely, these blades 997 create a suction air current and a discharge air current parallel to the shaft 110. The blades 997 can be attached to the shaft 110 by means of a shaft 998. These blades 997 can also be attached directly to the rotor by means of an arm 999.

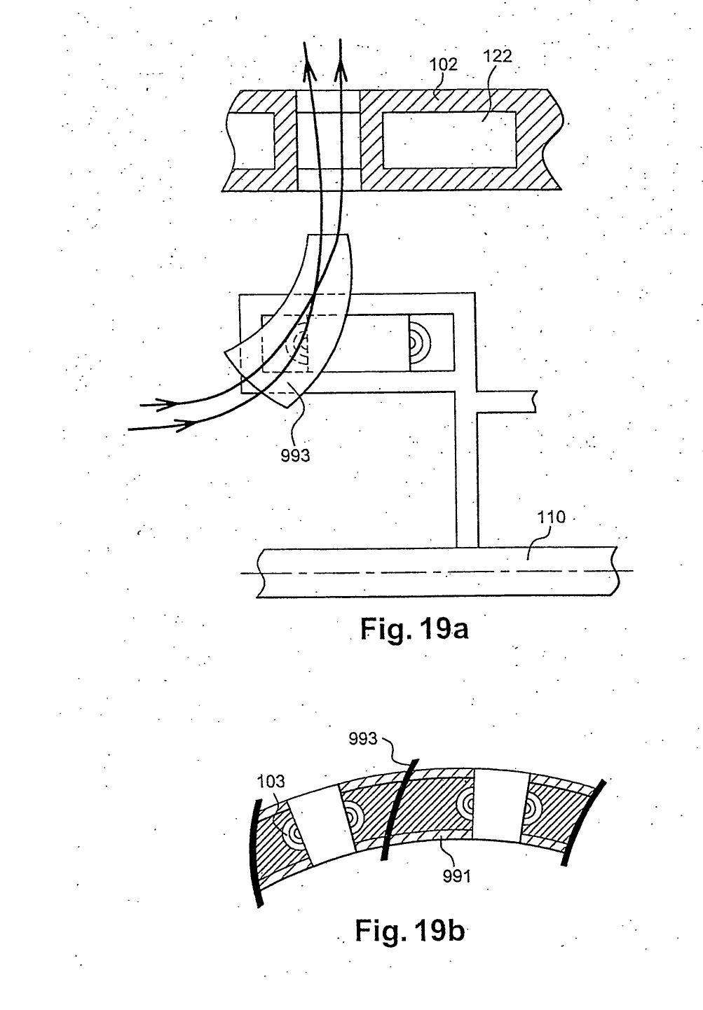

FIG. 19a show centrifugal or helico-centrifugal blades 993 mounted directly on a head of the rotor. The blades 993 have a profile in the shape of a comma. This is because these blades have two sides of an arc of a circle having the same curvature and connected together by two sides forming an angle that can in particular be substantially equal to 45°.

FIG. 19b shows in front view a mounting of centrifugal 992 or helico-centrifugal 993 blades having a curved shape and mounted on the ring 987 fixing the coils. The blades 993 are mounted directly on the ring in circular alternation with coil heads 103. In a variant, these blades are mounted directly on coils.

Naturally it is possible to combine axial and radial blades by integrating them on each side of the rotor, such as for example on the rotor and on the coils of the stator generator.

The apertures on the retarder are here hollowed out in the wall of the stators of the retarders. In a variant, these apertures are hollowed out in a casing or any other enclosure that surrounds a ventilation circuit consisting of the fans used inside the retarder.

In all the example embodiments of the inventions, it is possible to replace blades of a given type with centripetal or helico-centripetal blades so that a suction air current enters in a radial direction or a direction inclined with respect to the axis of the retarder shaft.

A fan that comprises the blades used in the invention is in general attached to the rotating elements, such as the rotors or the shaft of the retarder. In a first variant, this fan is disengageable. In such a fan, a driving of the blades in rotation is demanded by means of a control signal that is generally electrical. In a second variant, the fan is independent of the rotating elements of the retarder. In this second variant, the blades of the fan are not connected to the rotating elements of the retarder. The independent fan has its own drive means, such as a DC electric motor. The speed of rotation of the blades of the independent fan is independent of the speed of rotation of the rotating elements of the retarder.

Naturally all combinations are possible. Thus, in FIG. 1, the flanges of the fans are in a variant fixed at their internal periphery to a core intended to be secured to a portion of the shaft 110. The bars 655 in FIGS. 6a and 7b equip the rotor 101 in FIG. 1. In FIGS. 10a to 10b, the cores can be mounted on a central flange, the coils being wounded around axial cores and cooled for example by means of blades, of the same type as those in FIG. 14 fixed to the central flange attached to the shaft 110.

In the light of FIG. 13, it is possible to increase the number of rotors and therefore the number of chambers 122. These chambers can be produced in the radial wall or walls of the casing and/or in the axially oriented peripheral walls thereof.

In all cases, the bearing referenced 603 in FIG. 6a and acting between the shaft 110 and the casing 102 is well cooled. In FIG. 1, the rotor can have axial cores connected at of their ends to a flange and the heads of the coils can be produced by means of fins or other projections carried by each of the flanges.

In all the figures, the shaft 110 has an axis that is the axis of the rotor and of the retarder.

When there are several chambers, it is possible to supply these with cooling fluid at different flow rates in order to make the temperature uniform within the stator. The cooling liquid can be of a type other than that of the cooling liquid of the vehicle engine.

Thus, in FIG. 14, the flow rate of the central chamber 122 is greater than that of the lateral end chambers. In FIG. 15, the flow rate of cooling fluid in the top chamber, the one furthest away radially from the axis of the shaft 110, is greater than the flow rate in the bottom chamber.

In FIG. 1, the flow rate of cooling fluid in the chamber 112 is greater than that of the chamber 113. Everything depends on the application.

It is clear from the description and drawings that the word attached means secured to.

The generator has in the figures a rotor secured to the shaft 110 and a stator secured to the casing 102 and/or to the stator 170. In a variant, this generator, designed to electrically supply the coils, has brushes carried by the stator and annular tracks carried by the shaft 110. In a variant, at least one radial wall of the casing and/or of the stator is replaced by a wall inclined with respect to the axis of the rotor 110.

In FIGS. 15, 17, 18, 19 the induced rotor of the generator is carried by a sleeve fixed to the flange 980, itself next to the shaft 110. The induced rotor is therefore rotationally fixed to the shaft 110. The induced rotor is therefore rotationally fixed to the shaft 110. The same applies in the other figures, the presence of this cooling chamber or chambers is not obligatory. In all the figures, the stator carries, in the aforementioned manner, at least one cooling chamber.

Advantageously, the blades in the same series are distributed in an irregular manner in order to reduce noise. In a variant, the retarder stator is attached to the casing and has a body carrying at least one cooling chamber. It is this body that is attached to the casing.

1. Electromagnetic retarder comprising:
a rotor comprising coils and a body, this body being attached to
a shaft having an axis and driving the rotor in rotation,
a stator and/or casing surrounding or encasing the rotor,
means for producing a current of air,
a generator for electrically supplying the coils of the retarder rotor,
characterised in that it comprises
at least one inlet aperture enabling this current of air to enter and at least one discharge aperture enabling this current of air to exit and in that the at least one discharge aperture is produced between two cooling chambers or through one or more cooling chambers carried by the casing and/or the stator of the retarder.

2. Retarder according to claim 1, characterised in that the cooling chambers are connected together by a throttling throat.

3. Retarder according to claim 1, characterised in that the at least one inlet aperture is produced in a part of the wall of the stator and/or of the casing oriented so as to be radial or inclined with respect to the axis of the shaft in order to allow an entry of the air current favourably parallel to the shaft.

4. Retarder according to claim 1, characterised in that the at least one discharge aperture is produced in a part of the wall of the stator and/or of the casing oriented axially with respect to the axis of the shaft.

5. Retarder according to claim 1, characterised in that the it comprises at least one blade that creates a suction and discharge air current.

6. Retarder according to claim 5, characterised in that the blade comprises an opening in its base, this opening allowing an air current to pass.

7. Retarder according to claim 5, characterised in that the blade is an axial blade that creates a suction air current parallel to the axis of the shaft and a discharge air current parallel to this axis.

8. Retarder according to claim 1, characterised in that the rotor comprises at least one opening between the shaft and the coils, this opening allowing an air current to pass.

9. Retarder according to claim 1, characterised in that the generator rotor comprises at least one opening between the shaft and its coils, this opening allowing an air current to pass.

10. Retarder according to claim 1, characterised in that it comprises a disengageable fan.

11. Retarder according to claim 1, characterised in that it comprises an independent fan.
